(19) United States
(12) Patent Application Publication
(10) Pub. No.: US 2003/0097311 A1
(43) Pub. Date: May 22, 2003

(54) Custom product order acceptance supporting apparatus

(75) Inventors: Noriko Shinohara, Tokyo (JP); Kimio Iwasawa, Tokyo (JP)

Correspondence Address: BURNS DOANE SWECKER & MATHIS L L P, POST OFFICE BOX 1404, ALEXANDRIA, VA, 22313-1404, US

(73) Assignee: NEC Toppan Circuit Solutions, Inc., Tokyo (JP)

(21) Appl. No.: 10/295,918

(22) Filed: Nov. 18, 2002

(30) Foreign Application Priority Data
Nov. 19, 2001 (JP) 2001-352482

(51) Int. Cl. G06F 17/60

(52) U.S. Cl. 705/26

(57) ABSTRACT

An apparatus is disclosed for supporting acceptance of an order of a custom product. The apparatus is connected to a user terminal in a company through an Intranet and includes a price estimation unit, a price matching unit, a storage unit and a WWW server. The apparatus first provides, to a user having a user registration, a menu of functions which can be utilized based on a division of the user in response to an access from the user terminal. When the WWW server receives a price estimation request for a custom product including product specifications and negotiation information from the user terminal, the price estimation unit calculates an estimated price. When the price matching unit receives a price matching request from the price estimation unit, it transmits an e-mail to the terminal of a person who perform the price matching to urge the person to issue an answer to the price matching. Necessary data including specification matching of the past are registered in the storage unit. When the price matching unit receives the answer from the terminal of the person who performed price matching, it transmits the answer via e-mail to the terminal of a person who requested the price matching.

### BACKGROUND OF THE INVENTION

1. Field of the Invention

This invention relates to an apparatus for supporting, when an order of a custom product unique to a customer is accepted, a division which contacts directly with the customer and a division which supports the former division.

2. Description of the Related Art

In recent years, there is a great demand for custom products with characteristics unique to customers due to diversification of market needs. System product manufacturers also make every efforts at custom products with the aim of increasing the competitiveness of final products by differentiation from rival products. Product specifications and the price of a custom product inevitably differs among negotiations. In order to become a winner in the competition, an enterprise must tackle rapidly and accurately with negotiations to observe a plolicy of the consumer orientation and the serious consideration of customers.

A salesperson must present a rough estimate of the price to a customer at an initial stage of a negotiation, and, before he presents a formal estimated price, he must perform price matching with a business line (a sales promotion division, a design engineering division, a research & development division, a planning division, and a manufacturing division).

The price matching is conventionally performed in the following manner. The salesperson calculates an estimated price from requested specifications for a custom product of a customer, enters the calculated estimated price, a price requested by the customer, a price requested by the sales division, specifications (a customer name, an article name, an amount of orders accepted, a time limit for delivery, product specifications, and so forth) necessary for calculation of an estimated price, and the division and the name of the salesperson himself in a document, and submits the document to the sales promotion division. When the sales promotion division receives the document from the salesperson, it determine an actual price taking actual results of order acceptance of the past, a sales strategy and so forth into consideration, and applies an approval number to the case. The sales promotion division then enters the contents of the determination and the approval number in the document submitted from the salesperson, copies the document and returns the original document to the salesperson. The sales promotion division selects the approval number, an article name, a customer name, a price requested by the sales division, a price answered by the sales promotion division and main product specifications from the document copy to prepare a list. The list is utilized later to investigate actual results of order acceptance of the past or to predict order acceptance. The sales division presents to the customer an answered price from the sales promotion division entered in the returned document as an estimated price.

If the specifications requested by the customer require additional conditions to manufacture, then the salesperson must perform matching with the business line in advance. The matching is conventionally performed in the following manner. The salesperson first determines whether or not the specifications requested by the customer require additional conditions. When the specifications require some additional conditions, the salesperson enters the specifications and the division and the name of the salesperson into a document and submits the document to the sales promotion division. The sales promotion division confirms the contents of the document (whether or not the contents of the entry are imperfect and whether or not the requested specifications include an error). If it finds that the contents of the document are appropriate, then it applies an issue number to the document and submits the document to the design engineering division. If the contents of the document are inappropriate, then the sales promotion division returns the document to a person of the sales division who submitted the document. When the design engineering division receives the document from the sales promotion division, it determines whether or not the manufacture should be permitted after taking the actual result of order acceptance of the past, the sales strategy and other specifications into consideration, and enters the determined contents in the document. The design engineering division then submits the document to the planning division. When the planning division receives the document, it determines the price based on the answered result of the design engineering division and enters the determined contents in the document. The planning division then submits the document to the sales promotion division. When the sales promotion division receives the document, it produces a copy of the document and returns the original document to the salesperson. The sales promotion division picks up the issue number, article name, customer name and principal specifications from the document copy to prepare a list. The list is utilized later to investigate the actual result of order acceptance of the past. The sales division presents the answer entered in the returned document as a specification estimate to the customer.

Thereafter, when the negotiation is successful or failed, the salesperson enters the negotiation result in the document and distributes copies of the document to those divisions which have issued an answer of the price matching or the specification matching an answer (the sales promotion division, design engineering division, planning division). When the negotiation is successful, the salesperson prepares a document of the order acceptance information and submits it to a person who is in charge of the order acceptance plan and a person who is in charge of engineering.

Furthermore, after an order of a custom product is accepted, the customer may sometimes request an option article. When such a request is received, the request is conventionally dealt with in the following manner. The salesperson enters contents of the request by the customer, an article name of the option article, customer name and a division and the name of the salesperson himself in a document and submits the document to the sales promotion division.

The sales promotion division confirms contents of the document (whether or not the contents are imperfect). When it is confirmed that the documents are perfect, the sales promotion division applies an issue number to the documents and submits the document to a corresponding business line (design engineering division, planning division, manufacturing division). When it is confirmed that the document are imperfect, the sales promotion division returns the document to the person of the sales division who submitted the document. The business line manufactures the article in accordance with the contents of the request in the document and supplies the manufactured article to the sales division.

In the order acceptance supporting method for a custom product described above, however, price matching and specification matching are performed using forms. Therefore, the order acceptance supporting method for a custom product is disadvantageous in that paper is consumed uselessly, processing speed is low, and a result of the matching cannot be observed by another division and cannot be made the most of in a later negotiation.

Of course, price calculation and determination of specifications themselves may be executed through an application program installed on a terminal. This computer program executes detailed price estimation and manufacturing condition determination when requested specifications of a customer are entered. This allows accurate price estimation and manufacturing condition determination irrespective of the skill of the salesperson. However, such packaged program is disadvantageous in that due to cumbersome distribution and/or installation, it is difficult to cope rapidly with price or specifications which may vary every day, failing to satisfy customers.

Japanese Patent Laid-Open No. 269293/1998 “Work flow management method and apparatus for a steel product” can be mentioned as prior art document relating to an order acceptance supporting method for a custom product of the type described. Investigations of properness of manufacture of product specifications, presence or absence of the stock, manufacturing steps, the time limit for delivery and so forth regarding steel products as custom products are performed in a steel maker and need to be kept secret as know-how. However, in the prior art, in order to lay them open to a sales agency or the like, an in-company server and an external server are connected each other through a firewall to thereby provide a work flow between divisions which do not belong to the same LAN (Local Area Network) such as a steel maker and a sales agency.

The prior art document mentioned above, however, merely recites cooperation between an in-company server and an external server, and does not describe contents of the work flow regarding investigations of manufacturing and price of a custom product from a technical and manufacturing point of view, particularly price matching and specification matching.

### SUMMARY OF THE INVENTION

It is an object of the present invention to provide a custom product order acceptance supporting method and apparatus which is capable of performing cumbersome price matching and specification matching of a custom product accurately and rapidly.

It is another object of the present invention to provide a custom product order acceptance supporting method and apparatus which is capable of coping quickly with prices or contents of specifications which may vary every day.

In accordance with a first aspect of the present invention, a custom product order acceptance supporting apparatus is connected to a user terminal in a company through an Intranet and comprises price estimation means, price matching means, storage means, and a WWW (World Wide Web) server. The price estimation means calculates an estimated price when a price estimation request for a custom product including product specifications and negotiation information is received from the user terminal. When a price matching request is received from the price estimation means, the price matching means transmits an email to a terminal of a person who performs price matching to urge him to issue an answer of the price matching, and when the answer is received, transmits, the answer via email to the user terminal of who requested the price matching. The storage means stores data necessitated by the price estimation means and the price matching means and including price matching data of the past. The WWW server receives a request or an input from the user terminal, activate the price estimation means and the price matching means and transmits results of the process by the price estimation means and the price matching means to the user terminal.

According to the aspect, the custom product order acceptance supporting apparatus first provides, to a user having a user registration, a menu of functions which can be utilized based on a division of the user in response to an access from the user terminal. When the WWW server receives a price estimation request for a custom product including product specifications and negotiation information from the user terminal, the price estimation means calculates an estimated price. When the price matching means receives a price matching request from the price estimation means, it transmits an e-mail to the terminal of a person who performs the price matching to urge him to issue an answer of the price matching. Necessary data including specification matching data of the past are registered in the storage means. When the price matching means receives the answer from the terminal of the person who performs the price matching, it transmits the answer via e-mail to the terminal of a person who requested the price matching.

Accordingly, the person who performs the price matching can make a decision of an answer of the price matching rapidly with sufficient information. Further, the person who perform the price matching can perform order acceptance supporting which responds quickly to the price which may vary every day. Further, the person who performs the price matching may display a summary list of price matching requests obtained by the price matching means on the user terminal and select a product with regard to which the person desires to answer, to obtain detailed display of contents of the price matching request and display of actual results of the price matching of the past with regard to the same specifications. Therefore, information sufficient to determine an answer of the price matching can be obtained rapidly.

The price matching means registers a plurality of data regarding a customer requested price and a sales requested price for each of product uses and pieces of negotiation information in a table different from that of data of the product specifications and negotiation information in the storage means, price matching can be performed plural times for one product specification.

According to a second aspect of the present invention, a custom product order acceptance supporting apparatus is connected to a user terminal in a company through an Intranet and comprises specification analysis means, specification matching means, storage means, and a WWW server. The specification analysis means analyzes manufacturing conditions and recommended conditions when a specification analysis request for a custom product including product specifications and negotiation information is received from the user terminal. When a specification matching request is received from the specification analysis means, the specification matching means transmits an e-mail to a terminal of a person who performs the specification matching to urge him to issue an answer of the specification matching, and when the answer is received, transmits an e-mail to the user terminal of a person who requested the specification matching. The storage means stores data necessitated by the price estimation means and the price matching means and including price matching data of the past. The WWW server receives a request or an input from the user terminal to activate a corresponding means (the specification analysis means and the specification matching means) and transmits a result of the process performed by the specification analysis means and the specification matching means to the user terminal.

According to the aspect, the custom product order acceptance supporting apparatus first provides a user having a user registration with a menu of functions which can be utilized depending on a division of the user in response to an access from the user terminal. When the WWW server receives a specification analysis request for a custom product including product specifications and negotiation information from the user terminal, the specification analysis means analyzes manufacturing conditions and recommended specifications. Further, when a specification matching request is received from the specification analysis means, the specification matching means transmits an e-mail to the terminal of a person who performs the specification matching to urge him to issue an answer of the specification matching. When the answer is received, the specification matching means transmits an e-mail to the user terminal of a person who requested the specification matching to issue an answer of the specification matching. Necessary data including specification matching data of the past are registered in the storage means. When the specification matching means receives an answer of the price matching from the terminal of the person who performs the specification matching, it transmits the answer via e-mail to the terminal of a person who requested the specification matching.

Accordingly, the person who performs the specification matching can make a decision of an answer of the specification matching rapidly with sufficient information. Further, the person who performs the specification matching can perform order acceptance supporting which responds quickly to the specification which may vary every day. Further, the person who performs the specification matching may display a summary list of specification matching requests obtained by the specification matching means on the user terminal and select a product with regard to which he desires to answer to obtain detailed display of contents of the specification matching request and display actual results of specification matching of the past with regard to the same specification. Therefore, information sufficient to make a decision of an answer of the specification matching can be obtained rapidly.

The specification matching means registers a plurality of data regarding specifications and contents of the request by the customer for each one of the product specifications in a table different from that of data of the product specifications and negotiation information in the storage means, so that specification matching can be performed plural times for one product specification.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram of a system including a custom product order acceptance apparatus according to an embodiment of the present invention;

FIG. 2 is a block diagram illustrating various processes carried out by the custom product order acceptance system of FIG. 1;

FIG. 3 is a block diagram of a processor and a storage unit in a center server shown in FIG. 1;

FIG. 4 is a block diagram of a unit which executes price matching;

FIG. 5 is a block diagram of a unit which executes specification matching;

FIG. 6 is a view illustrating contents of data in a user registration storage unit;

FIG. 7 is a view illustrating contents of data of a mail transmission destination storage unit;

FIG. 8 is a view illustrating a definition of an object;

FIGS. 9A and 9B are flow charts of a user registration process;

FIG. 10 is a flow chart of a user authentication process;

FIG. 11 is a flow chart of a price estimation process;

FIG. 12 is a flow chart of a price matching requesting process;

FIGS. 13A and 13B are flow charts of a price matching answering process;

FIG. 14 is a flow chart of a price matching answer confirmation process;

FIG. 15 is a flow chart of a price matching cancellation process;

FIGS. 16A and 16B are flow charts of a price matching re-requesting process;

FIGS. 17A and 17B are flow charts of a negotiation result registration process by price matching;

FIG. 18 is a flow chart of a specification analysis process;

FIG. 19 is a flow chart of a specification matching requesting process;

FIGS. 20A, 20B and 20C are flow charts of a specification matching answering process;

FIG. 21 is a flow chart of a specification matching answer confirmation process;

FIG. 22 is a flow chart of a specification matching cancellation process;

FIGS. 23A and 23B are flow charts of a specification matching re-requesting process;

FIGS. 24A and 24B are flow charts of a negotiation result registration process by specification matching;

FIGS. 25A and 25B are flow charts of an order acceptance determination process;

FIG. 26 is a flow chart of an order acceptance determination process cancellation process;

FIG. 27 is a flow chart of an order acceptance determination process replacement process;

FIGS. 28A and 28B are flow charts of an option request execution process;

FIGS. 29A and 29B are flow charts of an option request answering process;

FIG. 30 is a flow chart of an option request answer confirmation process;

FIG. 31 is a flow chart of a report outputting process;

FIG. 32 is a flow chart of an urging process;

FIG. 33 is a flow chart of an interrupt approval process; and

FIGS. 34A and 34B are flow charts of an approval requesting process.

### EXPLANATION OF PREFERRED EMBODIMENTS

Referring now to FIG. 1, center server 5 which is a custom product order acceptance supporting apparatus according to an embodiment of the present invention is arranged in an information management division in a company and connected to a large number of user terminals 1 arranged in a sales division, a sales promotion division, a design engineering division, a research & development division, a planning division, a manufacturing division and so forth through an Intranet 6.

Each user terminal 1 is a personal computer or the like which has a Web browser and an electronic mail function. Center server 5 has WWW server 2, processor 3 and storage unit 4. Storage unit 4 stores user information, mail transmission destinations, price parameters, specification parameters and other data. Processor 3 refers to the data stored in storage unit 4 to perform predetermined processes in response to processing requests received through WWW server 2. WWW server 2 operates processor 3 in response to a processing request received from user terminal 1 through Intranet 6 and transmits a result of processing of processor 3 to user terminal 1 through Intranet 6. User terminal 1 displays the information transmitted thereto on a display unit to urge the user to issue a next processing request or information. Processes of processor 3 are recorded as a computer program on a computer-readable recording medium and read and executed by center server 5. The computer-readable recording medium may be any of recording media such as a floppy disk, a magneto-optical disk and a CD-ROM and storage apparatus built in a computer system such as a hard disk apparatus. Further, the computer-readable recording medium includes any recording medium (transmission medium or transmission wave) which dynamically retains a program for a short period of time as in a case where a program is transmitted through Internet or which retains a program for a fixed period of time like a volatile memory in a computer system which serves as a server in the case just described.

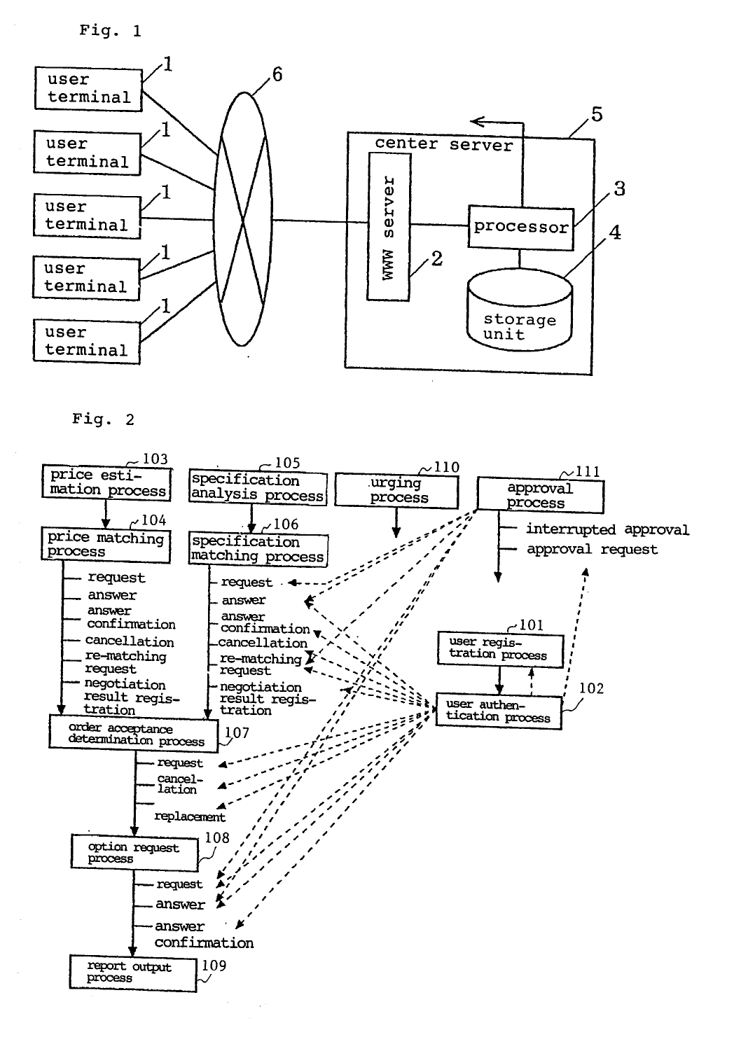

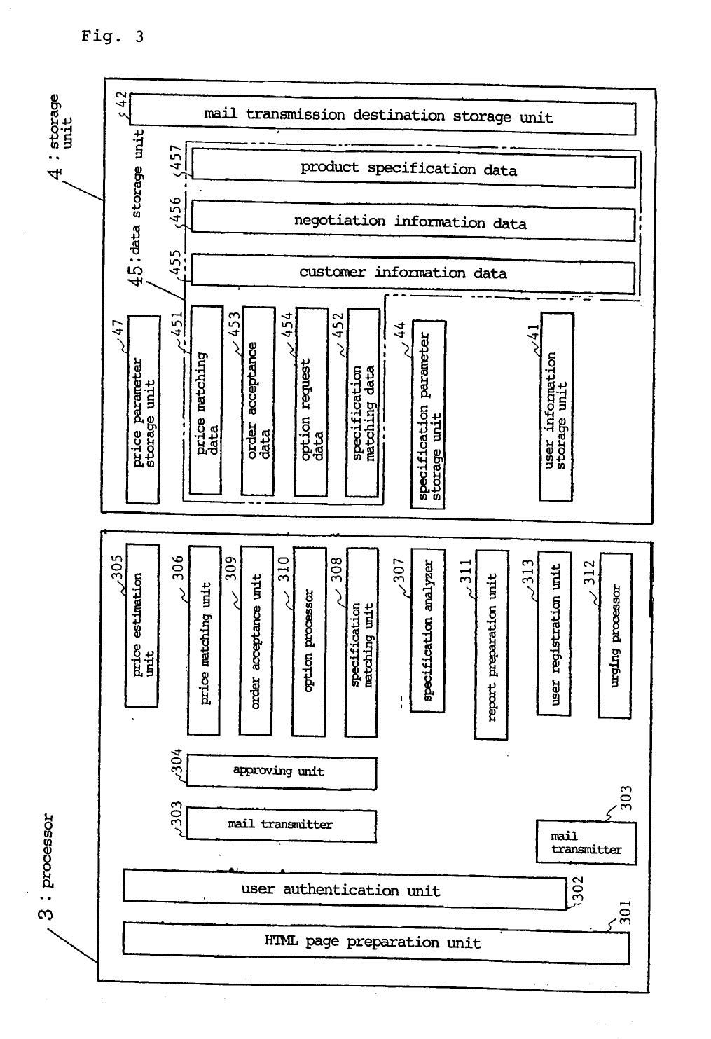

FIG. 2 shows processes executed by center server 5 shown in FIG. 1 in a mutually associated relationship. In order for a user in any division in the company to enjoy a service by center server 5, the user first accesses center server 5 from user terminal 1 to perform user registration process 101. The registered user information is stored in storage unit 4. The user who has become a client can enjoy the following services after he undergoes user authentication process 102 by center server 5.

A user in a sales division can request center server 5 for price estimation process 103 in the stage of a negotiation and can proceed to price matching process 104 with a business line. Price matching process 104 includes processes of price matching request, price matching answer, price matching answer confirmation, price matching cancellation, price re-matching request and negotiation result registration. Further, the sales division user can request specification analysis process 105 in the stage of a negotiation from center server 5 and further proceed to specification matching process 106 with the business line. Specification matching process 106 includes processes of specification matching request, specification matching answer, specification matching answer confirmation, specification matching cancellation, specification re-matching request and negotiation result registration. Price matching process 104 and specification matching process 106 are characteristic processes of the present invention.

After the negotiation proceeds and an order for manufacturing of a custom product is accepted, order acceptance determination process 107 including request, cancellation and replacement and option request process 108 when the customer requests an optional article relating to the custom product are performed as post-processes. Further, processes incidental to the processes described above involves report outputting process 109 to transmit a report to the customer who has enjoyed the present order acceptance supporting service, urging process 110 to urge a division, in which a process is stagnated, to do the process, and approval process 111 necessitated in order to execute a process. If an approver belongs to the same division, then interrupted approval is performed, but if the approver belongs to a different division, then an approval request is issued.

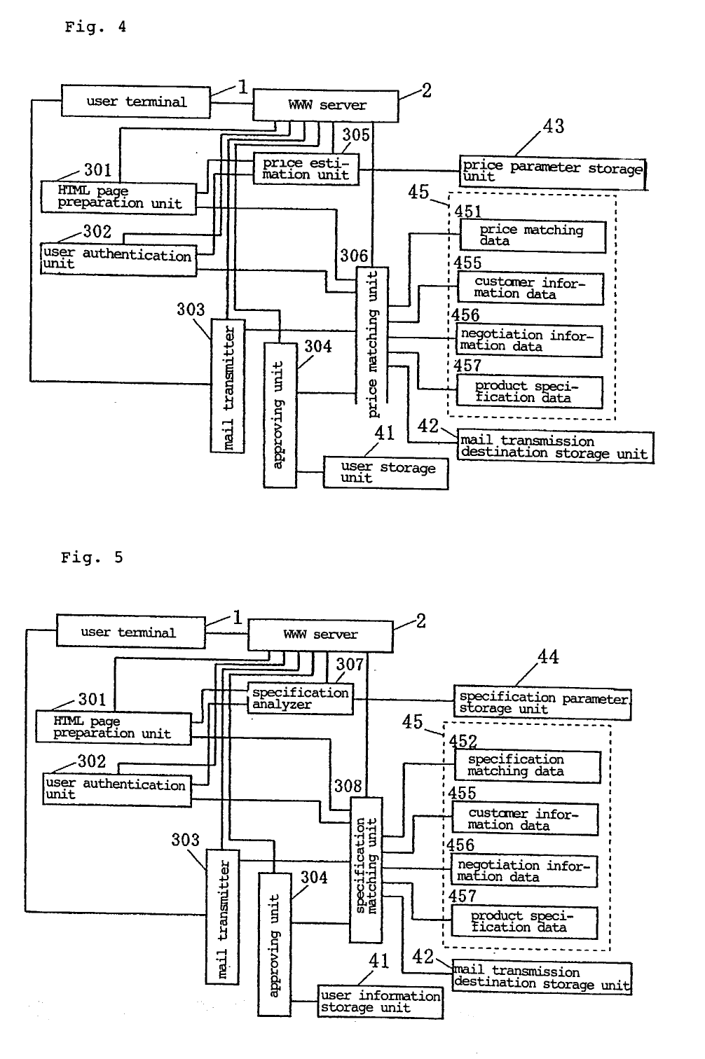

FIG. 3 shows a configuration of processor 3 and storage unit 4 in center server 5. As shown in FIG. 3, processor 3 comprises HTML page preparation unit 301, user authentication unit 302, mail transmitter 303, approval processor 304, price estimation unit 305, price matching processor 306, specification analyzer 307, specification matching processor 308, order acceptance processor 309, option processor 310, report preparation unit 311, urging processor 312 and user registration unit 313. Processors 301 to 313 are operated by www server 2, which receives a request or an input from user terminal 1, based on contents of the request or input and operate other processors 301 to 313. HTML page preparation unit 301 prepares HTML page data based on a result of the process, and WWW server 2 transmits the prepared HTML page data to user terminal 1.

Storage unit 4 includes user information storage unit 41, mail transmission destination storage unit 42, price parameter storage unit 43, specification parameter storage unit 44 and data storage unit 45. Data storage unit 45 stores price matching data 451, specification matching data 452, order acceptance data 453, option request data 454, customer information data 455, negotiation information data 456, and product specification data 457.

FIG. 4 shows a configuration of a unit extracted from FIG. 3 which executes price matching process 104 which is one of the characteristic functions of the present invention. As shown in FIG. 4, price matching process 104 is implemented by HTML page preparation unit 301, user authentication unit 302, mail transmitter 303, approval processor 304, price estimation unit 305, price matching processor 306, user information storage unit 41, mail transmission destination storage unit 42, price parameter storage unit 43 and data storage unit 45 (price matching data 451, customer information data 455, negotiation information data 456 and product specification data 457).

HTML page preparation unit 301 prepares HTML page data in the HTML (Hypertext Markup Language) to display the result of a process executed by a processor such as price estimation unit 305, price matching processor 306 or the like in accordance with an instruction from WWW server 2.

User authentication unit 302 checks coincidence of a user name and a password entered from user terminal 1 with data registered in user registration unit 313 to perform authentication of the user in accordance with an instruction from WWW server 2. For the user whose authentication has been successful, user authentication unit 302 prepares a menu screen for operation on user terminal 1.

Mail transmitter 303 transmits an e-mail to user terminal 1 of a predetermined mail address stored in user information storage unit 41 or mail transmission destination storage unit 42 in accordance with an instruction from WWW server 2.

Approval processor 304 supports approval of a process that requires approval by a predetermined approver (stored in user information storage unit 41), when each processor performs the process.

Price estimation unit 305 reads a calculation method for an estimated price stored in price estimation unit 305 and prices and constants for different ranges of specification items stored in price parameter storage unit 43, and calculates an estimated price, gradient prices for different amounts of orders accepted, additional prices for different specifications and so forth based on the information thus read.

Price matching processor 306 stores in data storage unit 45 data of product specifications, negotiation information and so forth entered through price estimation process 103 and prices requested by a customer and prices requested by a seller as well as a user name entered upon price matching request. Price matching processor 306 then reads from data storage unit 45 the product specifications and the requested price of a product selected by a person who performs the price matching and contents of price matching requests and contents of answers to the requests with regard to products of the same specifications of the past and supplies the read information to HTML page preparation unit 301. Following price matching process 104, price matching processor 306 reads an e-mail address of the person who performs the price matching stored in mail transmission destination storage unit 42. Price matching processor 306 performs support of price matching process 104 in this manner.

FIG. 5 shows a configuration of another unit extracted from FIG. 3 which executes specification matching process 106 which is another characteristic function of the present invention. As shown in FIG. 5, specification matching process 106 is realized by HTML page preparation unit 301, user authentication unit 302, mail transmitter 303, approval processor 304, specification analyzer 307, specification matching processor 308, user information storage unit 41, mail transmission destination storage unit 42, specification parameter storage unit 44 and data storage unit 45 (specification matching data 452, customer information data 455, negotiation information data 456 and product specification data 457).

Specification analyzer 307 reads a specification analysis method registered in specification analyzer 307 and manufacturing conditions for different ranges of specification items and specification analysis parameters of recommended specifications registered in specification parameter storage unit 44, and calculates manufacturing conditions, recommended specifications or actual results of manufacturing of the past based on the information thus read.

Specification matching processor 308 stores in data storage unit 45 data of product specifications, negotiation information and so forth entered through specification analysis process 105 and contents requested by a customer and a user name entered upon a specification matching request. When specification analysis process 105 is performed, specification matching processor 308 reads from data storage unit 45 product specifications and a requested price of a product selected by a person who performs the specification matching and contents of product data of requests and contents of answers to the request with regard to the same specifications and supplies the read information to HTML page preparation unit 301. Finally, specification matching processor 308 reads an e-mail address of a person who performs the specification matching stored in mail transmission destination storage unit 42. Specification matching processor 308 performs support of specification matching process 106 in this manner.

Next, of units 301 to 313 which compose processor 3 shown in FIG. 3, units 309 to 313 other than those shown in FIGS. 4 and 5 will be described. Order acceptance processor 309 prepares data to enter order acceptance particular information from user terminal 1 and stores order acceptance data 453 and a user name entered from user terminal 1 in data storage unit 45. Order acceptance processor 309 also refers to the stored data of data storage unit 45 and prepares data to cancel or replace such data.

Option processor 310 supports a process for requesting optional articles attached to a custom product when an acceptance of the order for the custom product is determined after price matching process 104 or specification matching process 106 have been performed.

Report preparation unit 311 prepares data to display the result of the order acceptance activities on user terminal 1 as a report.

When an answer satisfies urging conditions during the order acceptance activities, urging processor 312 transmits an urging e-mail to a pertinent division.

When a user registration request is received, user registration unit 313 checks a user name and user information and stores them in user information storage unit 41. Further, user registration unit 313 prepares a password of a user whose registration is permitted and stores the password in user information storage unit 41. User registration unit 313 reads the registered contents at a suitable point of time.

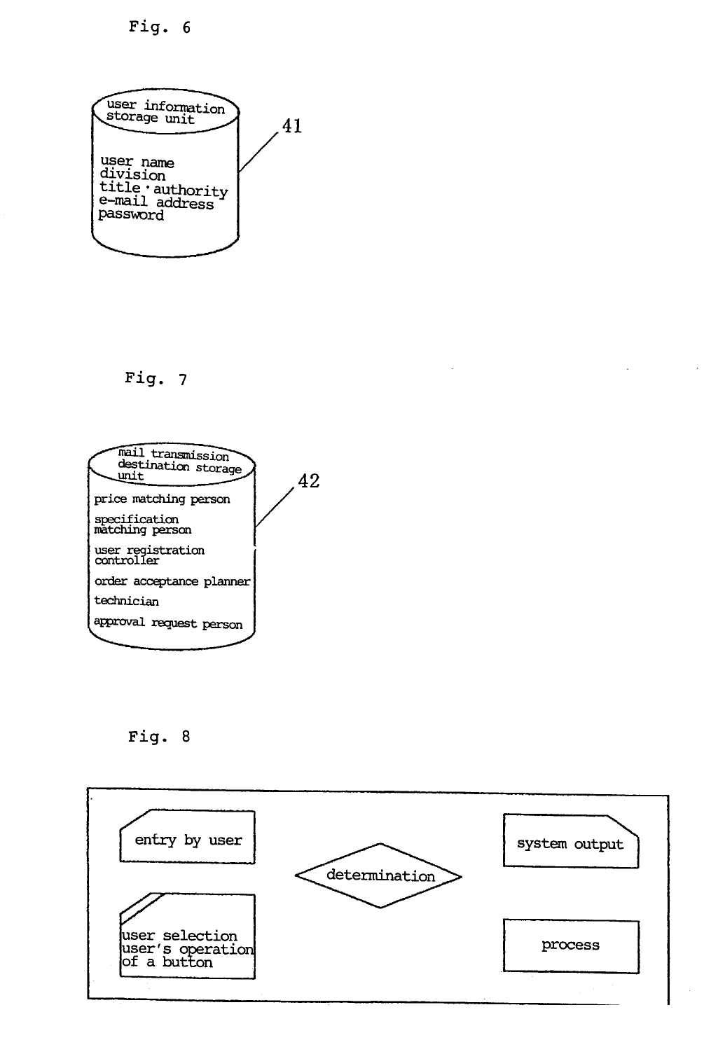

As shown in FIG. 6, user storage unit 41 stores therein user names and user information, which includes a division, a post, a mail address and a password of each user. Mail transmission destination storage unit 42 stores therein mail addresses of e-mail transmission destinations illustrated in FIG. 7 of a user registration manager and so forth. Price parameter storage unit 43 stores therein price constants for individual product specification items. Specification parameter storage unit 44 stores therein manufacturing conditions for different product specification items and recommended specifications.

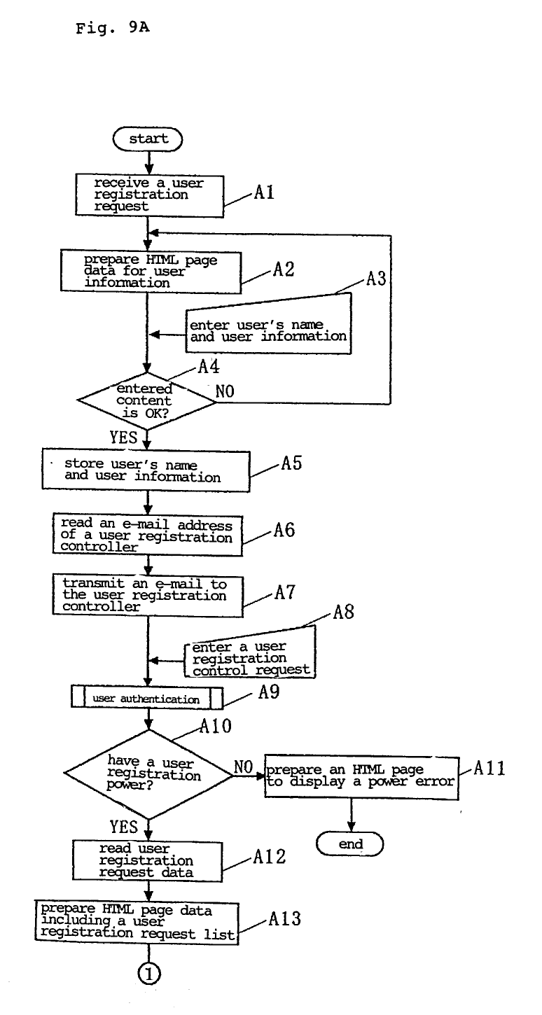

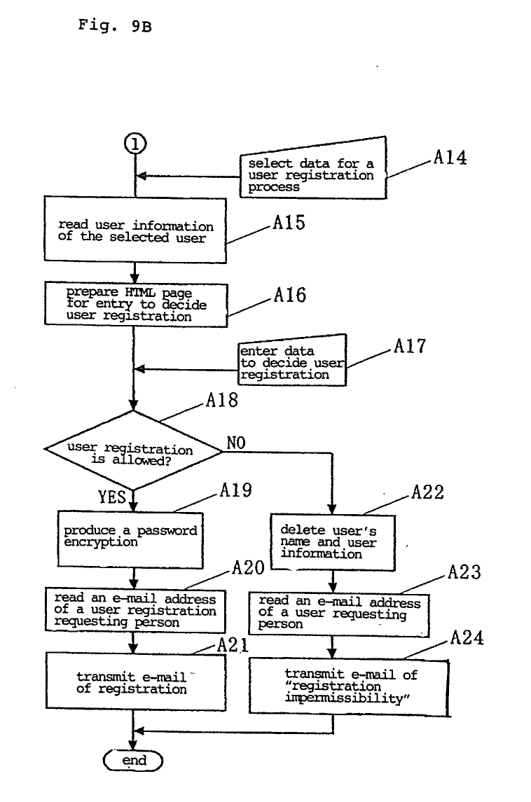

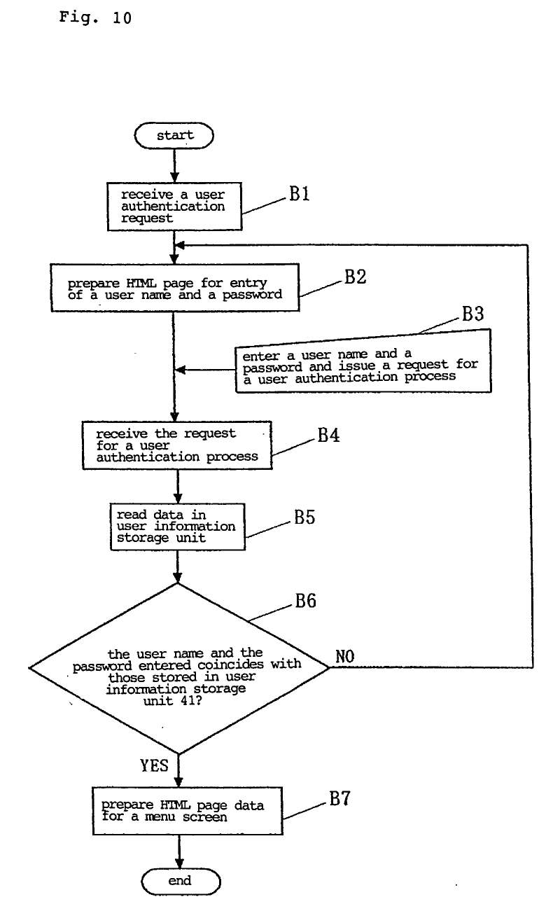

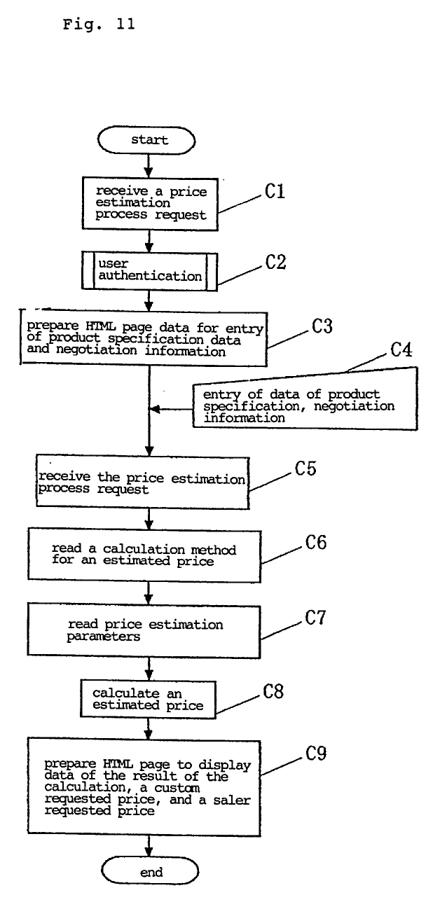

Operation of the present embodiment will now be described in detail with reference to flow charts of FIGS. 9 to 46. Such operation can be executed under a program control by processor 3 in center server 5. The object of the present invention includes entry by user, user selected button operation, determination, system output and process, as shown in FIG. 8.

1. User Registration Process 101 (FIGS. 9A, 9B)

In order for a user in the company to enjoy a service performed by center server 5, it is necessary for the user to perform user registration in user information storage unit 41 in advance. When WWW server 2 receives a user registration request of the user from user terminal 1 (step A1), it activates HTML page preparation unit 301 to prepare HTML page data to enter a user name and other user information (name, division, post, e-mail address of the user) from user terminal 1 (step A2). After HTML page data has been prepared, WWW server 2 transmits the HTML page data to user terminal 1. It is to be noted that, although entry and display based on the HTML page data are performed on user terminal 1, their description is omitted herein to avoid redundancy.

A person who desires to be registered as a user can enter user name and user information from user terminal 1 to issue a request for execution of user registration process 101 (step A3). In order to issue such a request for execution, the user may click a pertinent button or link on an HTML page displayed on user terminal 1. This description will not be repeated hereinafter to avoid redundancy. When WWW server 2 receives the request, it requests user registration unit 313 to check the input contents (step A4). The check involves determination as to whether or not data stored in user information storage unit 41 include the same user name as the entered user name, whether or not the mail address is a character string of en-size alphanumeric characters and/or special characters including ‘@’ at a position other than the opposite ends of the string, whether or not an alphabetical letter is included in a telephone number and so forth.

If user registration unit 313 discovers errors of the entered content or items whose data are not entered (NO at step A4), then the processing returns to step A2, at which HTML page preparation unit 301 prepares HTML page data for re-entry of a user name and user information. If the entered contents include no error (YES at step A4), then user registration unit 313 stores the user name and the user information in user information storage unit 41 (step A5). Simultaneously, user registration unit 313 reads an e-mail address of a user registration manager stored in mail transmission destination storage unit 42 (step A6), and mail transmitter 303 transmits to the user registration manager an e-mail notifying that a user registration request has been received (step A7). When the user registration manager issues a request for user registration management from user terminal 1 (step A8), WWW server 2 causes user authentication unit 302 to perform user authentication process 102 (step A9) and determines whether or not the user registration manager has a power as a user registration manager (step A10). It should be noted that the user authentication is for the user registration manager but not for a person who wants user registration. A procedure of user authentication process 102 will hereinafter be described with reference to a flow chart shown in FIG. 10. If the user registration manager does not have a power as a user registration manager (NO at step A10), then WWW server 2 causes HTML page preparation unit 301 to prepare an HTML page to display a power error (step A11). If the user registration manager has the power (YES at step A10), then user registration unit 313 reads the contents of the user registration request stored in user storage unit 41 (step A12), and HTML page preparation unit 301 prepares HTML page data to display a user registration request list (step A13).

The user registration manager may select a user as an object of the user registration process from the user registration request list displayed on user terminal 1 and issues a request for display of user information of the user (step A14). When WWW server 2 receives the request, user registration unit 313 reads from user storage unit 41 the user name and user information of a user for whom a user registration process is performed (step A15). HTML page preparation unit 301 prepares HTML page data to display the user information and to enter data as to whether or not the user registration should be accepted (step A16).

The user registration manager from user terminal 1 enters data as to whether or not the user registration is accepted (step A17). When WWW server 2 receives information representing that the user registration is accepted (YES at step A18), user registration unit 313 produces a password at random, encrypts the password and then stores the encrypted password in user information storage unit 41 (step A19). Simultaneously, user registration unit 313 reads an e-mail address of a person who requested the user registration stored in user storage unit 41 (step A20), and mail transmitter 303 transmits a notification that the user registration has been completed and the set password via electronic mail the person who requested the user registration (step A21). When WWW server 2 receives a request representing that the user registration has been rejected (NO at step A18), the user registration unit 313 deletes the user name and user information stored in user information storage unit 41 (step A22). Simultaneously, mail transmitter 303 transmits a notification that the user registration has been rejected via electronic mail to the person who requested the user registration (step A24).

2. User Authentication Process 102 (FIG. 10)

In order for a user to enjoy a service performed by center server 5, authentication of the user is necessitated for all processes except urging and approval for which such authentication is not necessary from their nature. When WWW server 2 receives a user authentication request from a user (step B1), it causes HTML page preparation unit 301 to prepare HTML page data to enter a user name and a password (step B2).

The user may enter the user name and password from user terminal 1 to issue a request for execution of a user authentication process (step B3). When WWW server 2 receives the request for execution of a user authentication process (step B4), user authentication unit 302 determines whether or not the entered user name and password coincides with the user names and passwords stored in user information storage unit 41, respectively (steps B5, B6). When no coincidence is found or the user name is not registered (NO at step B6), user authentication unit 302 determines that the user authentication was unsuccessful, and HTML page preparation unit 301 prepares HTML page data to re-enter a user name and a password (step B2).

On the other hand, when a coincidence is found (YES at step B6), user authentication unit 302 determines that the user authentication was successful, and user authentication unit 302 selects available functions from divisions and posts of the user and HTML page preparation unit 301 prepares HTML page data to display a menu screen (step B7). Processes such as price estimation process 103, price matching process 104 and specification analysis process 105 hereinafter described are activated when they are designated by the user on the menu screen.

User authentication unit 302 and HTML page preparation unit 301 operate to select and display available functions from the division and the post of the user in the following manner. Since a user who belongs to a sales division, for example, is not allowed to determine whether or not a product should be manufactured, user authentication unit 302 and HTML page preparation unit 301 do not prepare, for the user, a menu screen to establish a connection to a page to register an answer as to whether or not a product should be manufactured. Further, since a user whose post is a section chief or a higher post needs to perform electronic approval of data entered by his subordinate, user authentication unit 302 and HTML page preparation unit 301 prepare a menu screen to establish connection to a page for an electronic approval function.

3. Price Estimation Process 103 (FIG. 11)

A user, typically a salesperson may access, at an initial stage of a negotiation, center server 5 from user terminal 1 to acquire a price estimate and utilize it as a material for price matching with a customer or use it in sales activities. The user may cause user terminal 1 to display the menu screen transmitted from center server 5 at step B7 of FIG. 10 and select the “price estimation” from the menu screen to issue a price estimation process request to center server 5.

When WWW server 2 receives the price estimation process request from user terminal 1 (step C1), user authentication unit 302 performs user authentication (step C2), and HTML page preparation unit 301 prepares HTML page data to enter data of product specifications and negotiation information (step C3).

The user may enter data of product specifications, negotiation information and so forth from user terminal 1 to issue a request for execution of price estimation process 103 (step C4). When WWW server 2 receives the request for price estimation process (step C5), price estimation unit 305 reads a calculation method for an estimated price registered in price estimation unit 305 and prices and constants for different ranges of specification items stored in price parameter storage unit 43 (steps C6, C7), and calculates an estimated price, gradient prices for different amounts of orders accepted, additional prices for different specifications and so forth based on the read information (step C8). User authentication unit 302 prepares HTML page data for a result of the calculation (step C9). The HTML page data include data to enter price requested by a customer and requested by a seller when the processing advances to the next price matching process.

The calculation method for an estimated price stored in price estimation unit 305 is as follows. In the case of a printed circuit board as an example of a custom product, prices and constants for different ranges of specification items, for example +a yen for a four-layer plate, +b yen for a six-layer plate, +c yen for a thickness smaller than 0.4 mm, +d yen for a thickness equal to or greater than 0.4 mm but smaller than 0.6 mm, and a constant A by which a price is multiplied when a time limit for delivery is 3 days after from now, are registered in price parameter storage unit 43 in advance. The range of each specification item registered in price parameter storage unit 43 may be designated by a value such as a yen or an average value of data of the past. Price estimation unit 305 reads prices, constants and range designations stored in price parameter storage unit 43 (steps C6, C7) and adds or subtracts prices corresponding to the entered data or multiplies such prices by pertinent constants (step C8).

4. Price Matching Process 104 (FIGS. 4, 12 to 20)

Before the salesperson presents an estimated price to the customer, he must consult with the business division. At the last step in the price estimation (step C9 of FIG. 11), the user may enter a price requested by a customer and a price requested by a seller from user terminal 1 to issue a price matching request to center server 5 so that the processing may proceed from the price estimation to the price matching. Price matching process 104 includes processes of request, answer, answer confirmation, cancellation, re-request and negotiation result registration as successively described below.

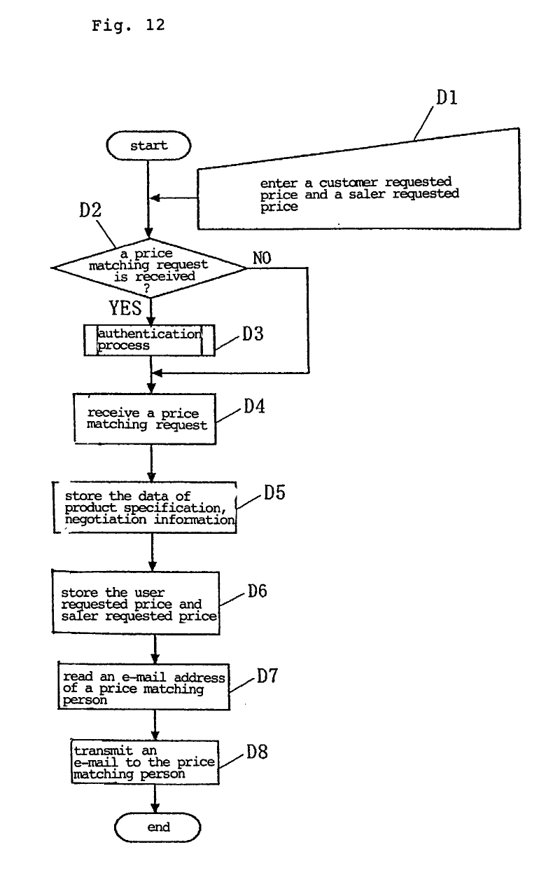

4.1 Price Matching Request (FIG. 12)

A user, typically a salesperson may enter a price requested by a customer and a price requested by a seller from user terminal 1 to issue a request for execution of a price matching to center server 5 (step D1). At this time, an approval request may be included in the request. The approval in this case refers to an approval by a request for price matching by the user.

When WWW server 2 receives the request for a price matching (YES at step D2), approval processor 304 performs an approval process (step D3), and after the approval process, WWW server 2 guides the user so that he may issue a request for execution of the price matching from user terminal 1. The approval process will hereinafter be described. When WWW server 2 fails to receive an approval request (NO at step D2), WWW server 2 skips step D3 and guides the user to a request for execution of the price matching. The guide is intended to give operations on a screen based on the HTML page data displayed on user terminal 1.

When WWW server 2 receives the request for execution of the price matching (step D4), price matching processor 306 stores the data of product specifications, negotiation information and so forth entered (at step C4 of FIG. 11) through price estimation process 103 in data storage unit 45 as product specification data 457, negotiation information data 456 (step D5). Simultaneously, price matching processor 306 also stores the price requested by a user and the price requested by a seller as well as the user name entered at step D1 as price matching data 451 in data storage unit 45 (step D6). The data of the price requested by a customer and the price requested by a seller are stored in a coordinated relationship in a table different from the table of the data of the product specifications, negotiation information and so forth. This means that data are associated in a 1:N relationship so that price matching can be performed plural times for one product specification Simultaneously, price matching processor 306 reads an e-mail address of the person who performs the price matching stored in mail transmission destination storage unit 42 (step D7), and mail transmitter 303 transmits to the person by e-mail a notification that the price matching request has been received (step D8).

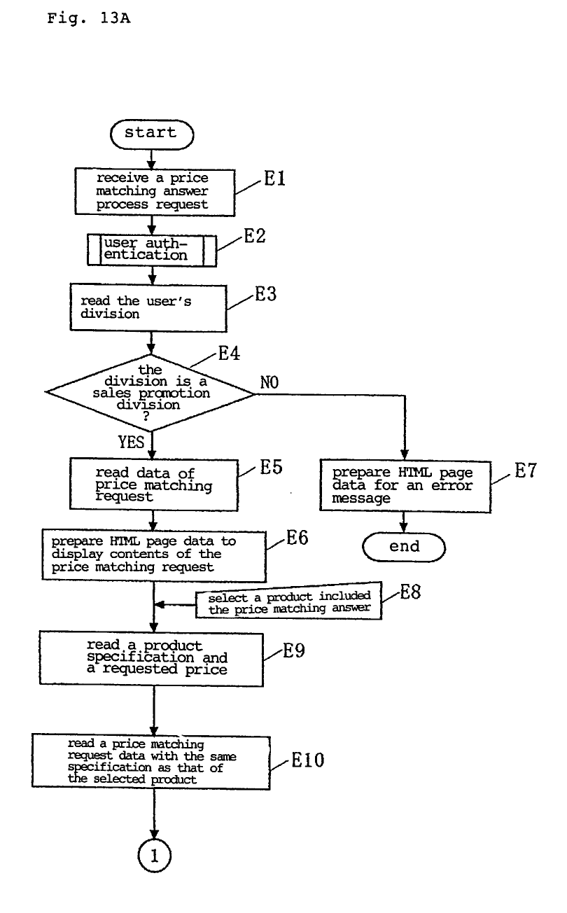

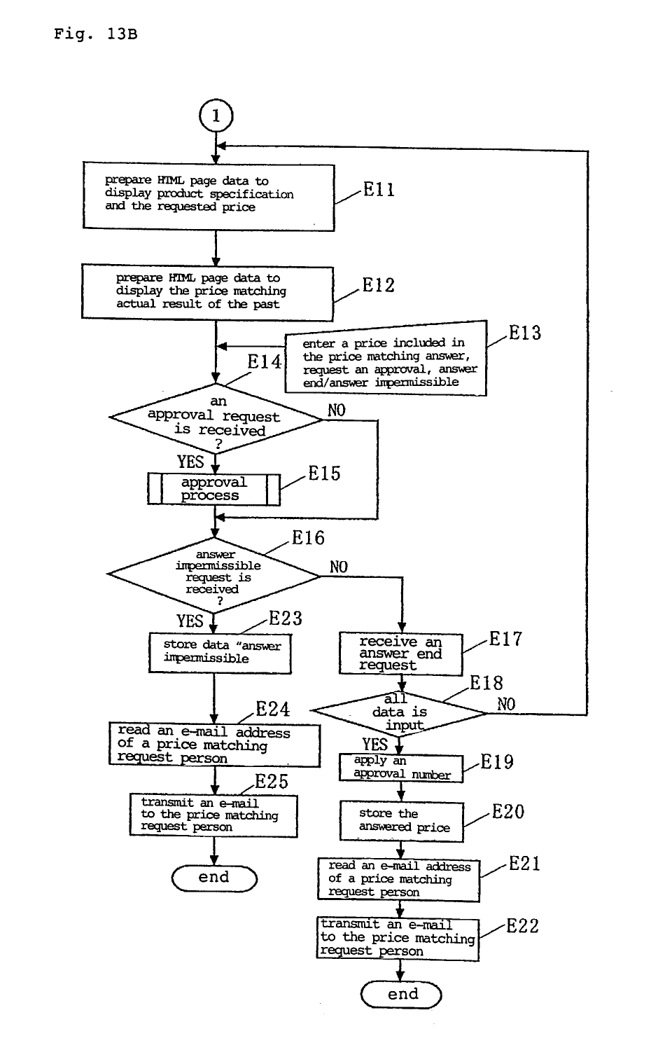

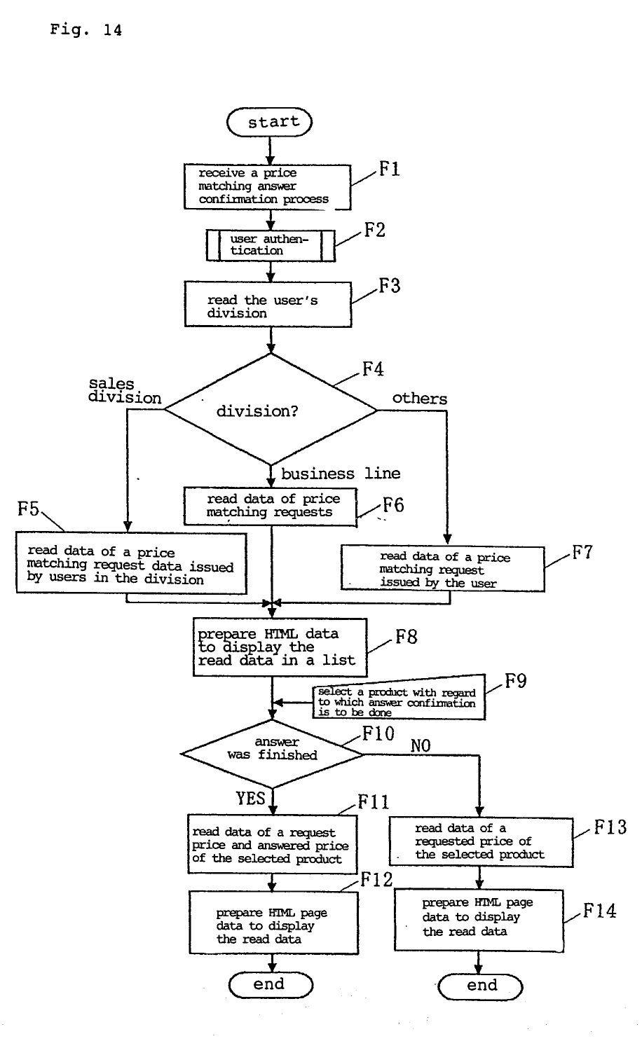

4.2 Price Matching Answer (FIGS. 13A, 13B)

When a person who performs the price matching answers the result of the price matching, he may issue a request for a price matching answer process from user terminal 1 to center server 5. When WWW server 2 receives the request for the price matching answer process from the user (step E1), user authentication unit 302 performs user authentication (step E2) and then reads the division of the user stored in user information storage unit 41 (step E3). The price matching answer is an item of arbitrary power of the sales promotion division.

When the division of the user is the sales promotion division (YES at step E4), price matching processor 306 reads data of price matching requests from data storage unit 45 (step E5) and HTML page preparation unit 301 prepares HTML page data to display contents of the price matching request in a list (step E6). When the division of the user is a division other than the sales promotion division (NO at step E4), HTML page preparation unit 301 prepares HTML page data to display an error message representing that the division has no connection right (step E7), and does not prepare HTML page data to display contents of the price matching request in a list.

The user may select a product to be answered as a result of the price matching from the price matching request content list on user terminal 1 and issue a request for the display of specifications of the selected product, the requested price, and an answer price entering screen (step E8). When WWW server 2 receives the request, price matching processor 306 reads the product specifications and the requested price stored (at steps D5, D6 of FIG. 12) in data storage unit 45 (step E9). Simultaneously, price matching processor 306 reads the contents of the price matching request and the content of the answers for products having the same specifications as those of the product selected at step E8 from data storage unit 45 (step E10). The contents are price matching actual result data of the past and are used as a reference for the current price matching.

HTML page preparation unit 301 prepares HTML page data to display the product specifications and the requested price read at step E9 and to enter an answer price (step E11). Further, HTML page preparation unit 301 prepares HTML page data to display the price matching actual results of the past with regard to the same specification as that read at step E10 (step E12).

The user may determine an answer price based on the displayed contents and enter the answer price from user terminal 1 (step E13). The user may additionally enter a request for approval. When WWW server 2 receives the request from the user terminal (YES at step E14), approval processor 304 performs an approval process (step E15), and after the approval process, WWW server 2 guides the user to issue a request for an answer end or “answer impermissibility” from user terminal 1 (step E13). Since it is not likely to occur at all that, when an approval request is issued, an answer cannot be given, and the determination at next step E16 is “NO” without fail. When WWW server 2 does not receive an approval request from the user terminal (NO at step E14), WWW server 2 skips step E15 and guides the user to issue a request for an answer end or “answer impermissibility”. “Answer end” means that a matching price has successfully been answered, and “answer impermissibility” means that it is impermissible answer a matched price for some reason.

When the user issues an answer end request (NO at step E16), and WWW server 2 receives the request (step E17), price matching processor 306 confirms that an answer has been entered (step E18) and applies an approval number to the answer based on a numbering method registered price matching processor 306, and then stores the answer price in data storage unit 45 (step E20). Simultaneously, price matching processor 306 reads from data storage unit 45 the user name of the user who requested the price matching and reads an e-mail address stored in user information storage unit 41 from the user name (step S21), and mail transmitter 303 transmits an e-mail of an answer end to the user who requested the price matching. When an answer has not been entered or there are some items whose data are not entered (NO at step E18), HTML page preparation unit 301 prepares HTML page data to display that there are some items whose data are not entered and to enter an answer price (step E11).

On the other hand, if WWW server 2 receives an answer impermissibility request (YES at step E16), price matching processor 306 stores “answer impermissibility” in data storage unit 45 (step E23). Simultaneously, price matching processor 306 reads from data storage unit 45 the user name of the user who requested the price matching and reads the e-mail address of the user name stored in user storage unit 41 (step E24), and mail transmitter 303 transmits an e-mail of “answer impermissibility” to the user who requested the price matching (step E25).

4.3 Price Matching Answer Confirmation (FIG. 14)

A user in each division in the company may issue a request for price matching answer confirmation process from user terminal 1 to center server 5 in order to confirm the answer of the price matching. When WWW server 2 receives the request (step F1), user authentication unit 302 performs user authentication (step F2) and reads the division of the user stored in user information storage unit 41 (step F3). User authentication unit 302, then determines whether the division is a sales division, a business line (sales promotion division, design engineering division, research & development division, a planning division, and a manufacturing division), or any other division (step F4).

When the division is the sales division, price matching processor 306 reads from data storage unit 45 data of price matching requests issued by users of the same sale division (step F5), and HTML page preparation unit 301 prepares HTML page data to display the read data in a list (step F8). This is performed because there may be some data which are not desirable to be known to divisions other sales division even in the same company for sales strategy. When the division of the user is the business line, price matching processor 306 reads data of all price matching requests from data storage unit 45 (step F6), and HTML page preparation unit 301 prepares HTML page data to display the read data in a list (step F8). This is because the business line needs to grasp all data of price matching requests. When the user belongs to a division other than the sales division and the business line, price matching processor 306 reads data of price matching requests requested by the user himself from data storage unit 45 (step F7), and HTML page preparation unit 301 prepares HTML page data to display the read data in a list (step F8). This is because a user who belongs to a division other than the sales division and the business line has the least power as far as the price matching is concerned.

The user may select a product with regard to which answer confirmation is desired to be performed from the price matching request list on user terminal 1 to issue a request to display the specification, the requested price and the answered price (step F9). When WWW server 2 receives the request, if an answer was already issued (YES at step F10), price matching processor 306 reads the specification of the selected product, the requested price and the answer price from data storage unit 45 (step F11). HTML page preparation unit 301 prepares HTML page data to display the read data (step F12). On the other hand, if no answer has been issued (NO at step F10), then price matching processor 306 reads the specification and the requested price of the product from data storage unit 45 (step F13), and HTML page preparation unit 301 prepares HTML page data to display the content of the request, a processing state and contents of a next process (step F14).

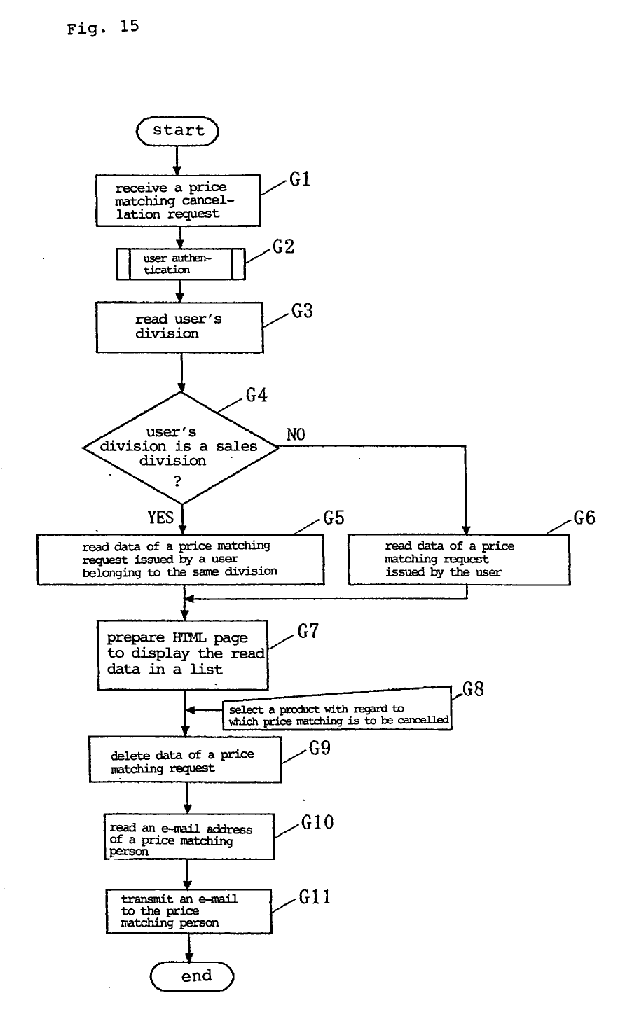

4.4 Price Matching Cancellation (FIG. 15)

An answer to a submitted price matching request may become unnecessary for some reason, such as change of the specification for the convenience of the customer. In this case, the user may issue a request for price matching cancellation from user terminal 1. When WWW server 2 receives the request for price matching cancellation (step G1), user authentication unit 302 performs user authentication (step G2) and reads the division of the user stored in user information storage unit 41 (step G3).

When the division is the same sales division (YES at step G4), price matching processor 306 reads data of price matching requests issued by users of the sales division from data storage unit 45 (step G5), and HTML page preparation unit 301 prepares HTML page data to display the read data in a list (step G7). Although such price matching cancellation should originally be performed by the person himself who requested, this is widely permitted because the same sales division performs sales activities in a team. When the division of the user is a division other than the sales division (NO at step G4), price matching processor 306 reads data of price matching requests of the user himself from data storage unit 45 (step G6), and HTML page preparation unit 301 prepares HTML page data to display the read data in a list (step G7).

The user may select a product with regard to which the price matching request is desired to be cancelled from the price matching request list and issue a request for price matching cancellation (step G8). When WWW server 2 receives the request, price matching processor 306 deletes data of the requested price, user name and so forth registered in data storage unit 45 (step G9) and simultaneously reads an e-mail address of the person who performed the price matching in mail transmission destination storage unit 42 (step G10), and mail transmitter 303 transmits to the person by an e-mail a notification that the price matching request has been cancelled (step G11).

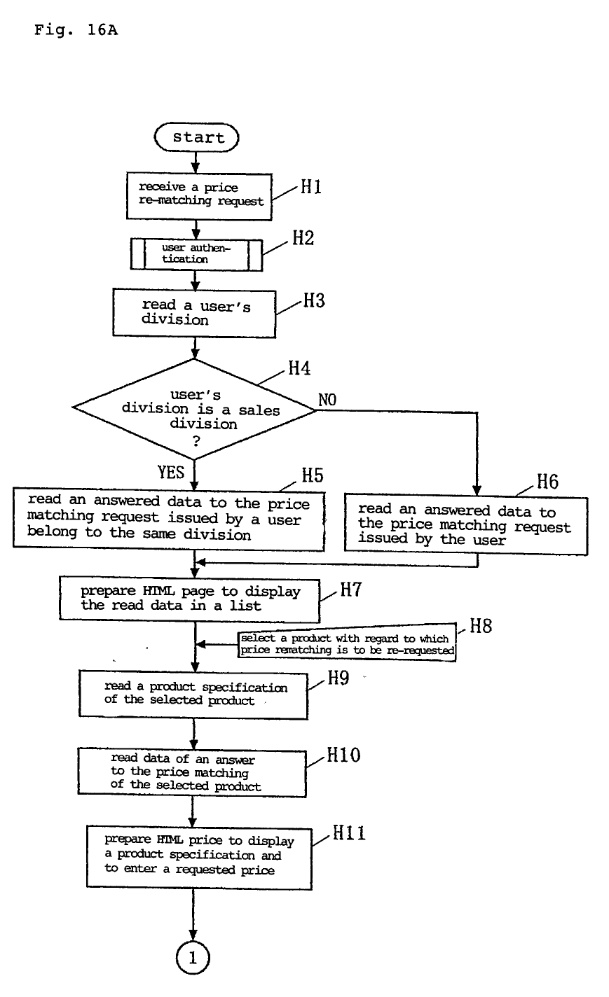

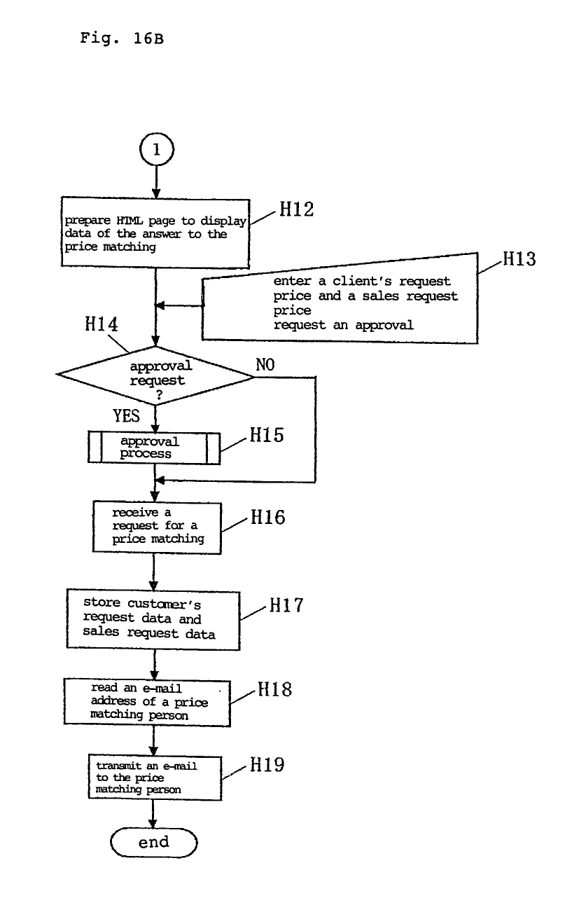

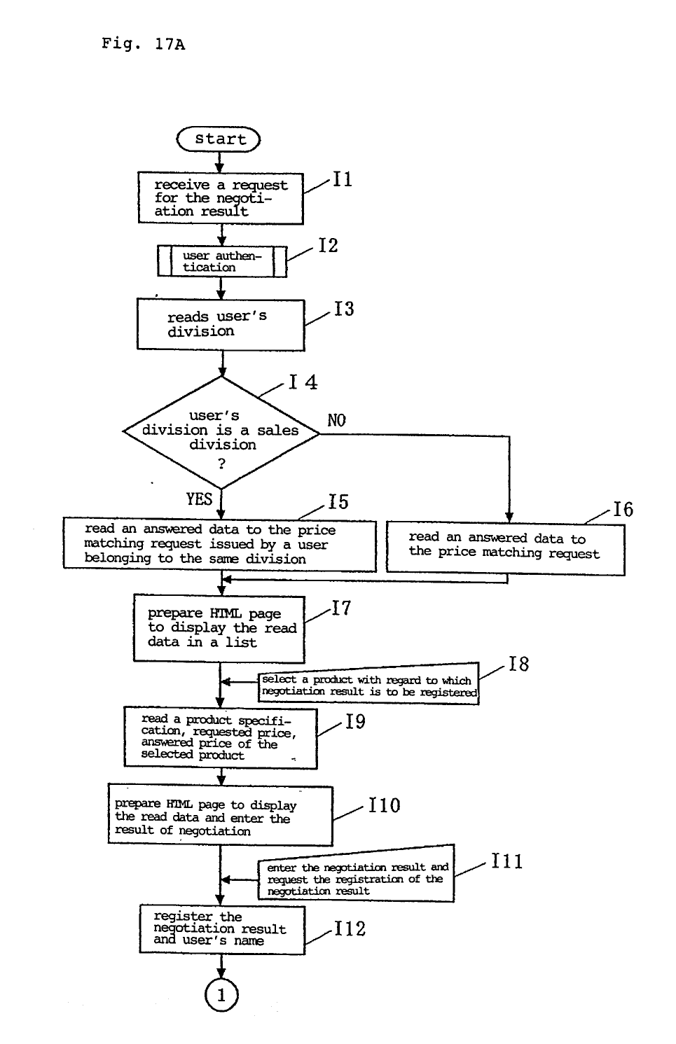

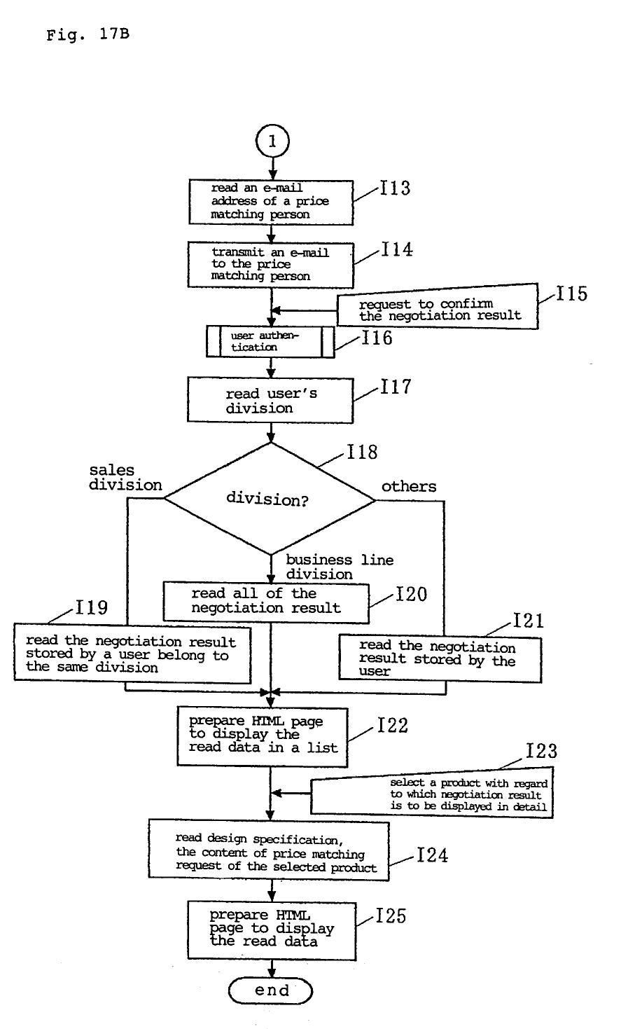

4.5 Price Re-Matching Request (FIGS. 16A, 16B)

A user who has issued the price matching request and confirmed an answer but is not satisfied with the answer may issue a price matching request again to center server 5 from user terminal 1. When WWW server 2 receives the request for price re-matching (step H1), user authentication unit 302 performs user authentication (step H2) and reads the division of the user registered in user storage unit 41 (step H3).

If the division is the sales division (YES at step H4), price matching processor 306 reads answer data to price matching requests issued by users of the same sales division from data storage unit 45 (step H5), and HTML page preparation unit 301 prepares HTML page data to display the read data in a list (step H7). If the division is a division other than the sales divisions (NO at step H4), price matching processor 306 reads the answer data to price matching requests issued by the user himself from data storage unit 45 (step H6), and HTML page preparation unit 301 prepares HTML page data to display the read data in a list (step H7).

The user may select a product with regard to which a price re-matching request is desired to be issued from the price matching request answer list and issue a request for displaying an enter screen for product specifications and a requested price (step H8). When WWW server 2 receives the request, price matching processor 306 reads product specifications registered in data storage unit 45 (step H9), and HTML page preparation unit 301 prepares HTML page data to display the product specifications and enter a requested price (step H11). Further, price matching processor 306 reads price matching data 451 of the past from data storage unit 45 (step H10) and prepares HTML page data to display the read price matching data 451 of the past (step H12). In this case, since product specifications were already registered in data storage unit 45, the product specifications are only displayed, and HTML page data to enter product specifications are not prepared.

The user can enter a requested price from user terminal 1 and issue a request for approval of the requested price (step H13). When WWW server 2 receives the approval request from the user terminal (YES at step H14), approval processor 304 performs an approval process (step H15), and after the approval process, WWW server 2 guides the user to issue a price matching execution request (step H13). When WWW server 2 does not receive an approval request from the user (NO at step H14), WWW server 2 skips step H15 and guides the user to issue a request for execution of a price matching.

When WWW server 2 receives the request for execution of the price matching (step H16), price matching processor 306 registers the requested price and the user name in data storage unit 45 (step H17). The data are registered as data separate from the data of price matching requests of the past. This is because it is intended to register the data in a 1:n coordinated relationship so that price matching may be performed plural times for one product specification. Simultaneously, price matching processor 306 reads an e-mail address of the person who performs the price matching person registered in mail transmission destination storage unit 42 (step H18), and mail transmitter 303 transmits to the person by an e-mail a notification that a request for the price matching to the person who performs the price matching has been received (step H19).

4.6 Negotiation Result Registration (FIGS. 17A, 17B)

The user will present the price matching result as an estimated price to the customer and proceeds with the negotiation. Thereafter, when the negotiation results in success or failure, the result must be transmitted to the business line. When the negotiation results in failure, the user may issue a request for negotiation result registration to center server 5 from user terminal 1. When WWW server 2 receives the request for negotiation result registration (step I1), user authentication unit 302 performs user authentication (step I2) and reads the division of the user registered in user information storage unit 41 (step I3).

When the division is the sales division (YES at step I4), price matching processor 306 reads answer data to price matching requests issued by users of the same sales division from data storage unit 45 (step I5), and HTML page preparation unit 301 prepares HTML page data to display the read data in a list (step I7). When the division of the user is a division other than the sales division (NO at step I4), price matching processor 306 reads answer data of price matching requests issued by the user himself from data storage unit 45 (step I6), and HTML page preparation unit 301 prepares HTML page data to display the read data in a list (step I7).

The user may select a product with regard to which negotiation result registration is desired to be performed from the price matching request answer list on user terminal 1 and issue a request for display of a negotiation result entering screen (step I8). When WWW server 2 receives the request, price matching processor 306 reads the product specifications of the selected product, the requested price and the answer price data from data storage unit 45 (step I9), and HTML page preparation unit 301 prepares HTML page data to display the product specifications, requested price and answer price and to enter a negotiation result (step I10).

The user may enter the negotiation result from user terminal 1 to issue a request for execution of the negotiation result registration (step I11). When WWW server 2 receives the request for execution of the negotiation result registration, price matching processor 306 stores the negotiation result and the user name in data storage unit 45 (step I12). Simultaneously, price matching processor 306 reads the e-mail address of person who performs the price matching stored in mail transmission destination storage unit 42 (step I13), and mail transmitter 303 transmits to the person via an e-mail a notification that negotiation result registration has been performed (step I14).

Further, the user can issue a request for confirmation of the negotiation result from user terminal 1 (step I15). When WWW server 2 receives the request for confirmation of the negotiation result, user authentication unit 302 performs user authentication (step 116) and reads the division of the user registered in user information storage unit 41 (step I17), and then determines the division of the user (step I18).

When the division is the sales division, price matching processor 306 reads negotiation result of users of the same sales division from data storage unit 45 (step 119), and HTML page preparation unit 301 prepares HTML page data to display the read data in a list (step I22). When the division of the user is the business line, price matching processor 306 reads all negotiation result from data storage unit 45 (step I20), and HTML page preparation unit 301 prepares HTML page data to display the read data in a list (step I22). When the division of the user is a division other than the sales division and the business line, price matching processor 306 reads the negotiation result of the user himself from data storage unit 45 (step I21), and HTML page preparation unit 301 prepares HTML page data to display the read data in a list (step I22).

The user may further select a product with regard to which particulars of the negotiation result is desired to be displayed from the negotiation result list on user terminal 1 and issue a request for display of the particulars to center server 5 (step I23). When WWW server 2 receives the request for display of particulars of the negotiation result, price matching processor 306 reads design specifications of the selected product, matching request, matching answer, negotiation result and so forth from data storage unit 45 (step I24), and HTML page preparation unit 301 prepares HTML page data to display the read data (step I25).

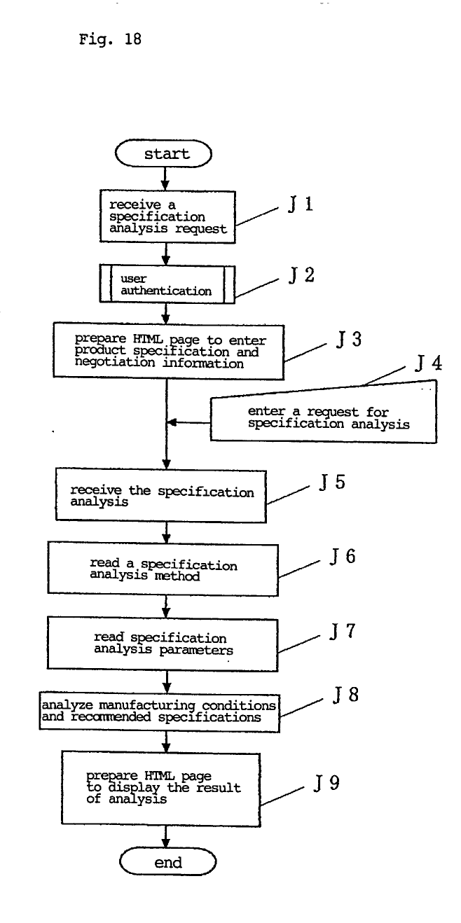

5. Specification Analysis Process 105 (FIG. 18)

A user may access center server 5 from user terminal 1 to issue a request for specification analysis process. The user may cause user terminal 1 to display the menu screen transmitted from center server 5 at step B7 of FIG. 10 and select the “specification analysis” from the menu screen to issue a request for specification analysis process to center server 5.

When WWW server 2 receives the request for a specification analysis from user terminal 1 (step J1), user authentication unit 302 performs user authentication (step I2) and prepares HTML page data to enter data of product specifications, negotiation information and so forth (step J3).

The user may enter product specifications and negotiation information from user terminal 1 to issue a request for specification analysis process 105 (step J4). When WWW server 2 receives the specification analysis request (step J5), specification analyzer 307 reads a specification analysis method registered in specification parameter storage unit 44 (step J6) and reads product conditions for different ranges of specification items and specification analysis parameters of recommended specifications registered in specification parameter storage unit 44 (step J7), and calculates manufacturing conditions, recommended specifications, actual results of manufacturing of the past and so forth based on the read information (step J8). HTML page preparation unit 301 prepares HTML page data for a result of the calculation (step J9). The HTML page data also include data for entry of a time limit for the delivery of the specification matching, contents of the request and the requested price when the processing advances to the next specification matching.

The specification analysis method registered in specification analyzer 307 is as follows. In the case of a printed circuit board as an example of a custom product, manufacturing conditions and recommended specifications for different ranges of specification items, for example, an eight-layer plate with a thickness less than 0.4 mm is outside the manufacturing range; the recommended thickness is 0.6 mm or more; and an eight-layer plate with thickness equal to or greater than 0.4 mm but smaller than 0.6 mm can be manufactured if the product size is a mm×b mm, are registered in parameter storage unit 44 in advance. The range of each specification item registered in specification parameter storage unit 44 may particularly be designated by a value such as a mm or an average value of data of the past. Specification analyzer 307 reads the manufacturing conditions, recommended specifications and range designations registered in specification parameter storage unit 44 (step J7) and calculates manufacturing conditions and recommended specifications corresponding to the data entered upon request of the specification analysis (step J8).

6. Specification Matching Process 106 (FIGS. 5, 19 to 24B)

A salesperson must consult with the business line in advance when specifications requested by a customer require some additional condition for the manufacture. The additional condition refers to a limited quantity of a custom product which can be manufactured in one month because of the severe specifications and a small number of part makers, for example. At the last step of the specification analysis (step J9), the user enters a time limit for delivery of the specification matching, contents of the request, and a requested price from user terminal 1 to issue a specification matching request to center server 5, so that the processing can proceed to the specification matching. The specification matching undergoes processes of request, answer, price confirmation, cancellation, re-request and negotiation result registration as successively described below and similarly to the price matching.

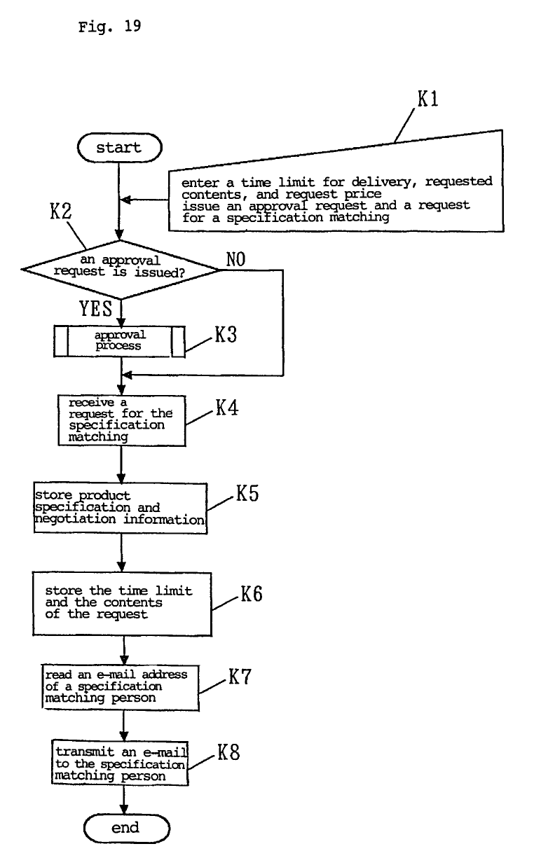

6.1 Specification Matching Request (FIG. 19)

A user, typically a salesperson may enter a time limit for delivery of the specification matching, contents of the request and a requested price from user terminal 1 to issue a request for execution of specification matching to center server 5 (step K1). In this case, the request may additionally include an approval request. The approval at this time refers to an approval for the request of the specification matching issued by the user.

When WWW server 2 receives the approval request (YES at step K2), approval processor 304 performs an approval process (step K3), and after the approval process, WWW server 2 guides the user to enter data of product specifications, negotiation information and so forth to issue a request for execution of a specification analysis process. When WWW server 2 does not receive the request of execution of the specification matching (NO at step K2), WWW server 2 skips step K3 and guides the user to request for execution of the specification analysis process.

When WWW server 2 receives the-request for execution of the specification analysis (step K4), specification matching processor 308 registers the data of product specifications, negotiation information and so forth entered (at step J4 of FIG. 18) through specification analysis process 105 as product specification data 457, negotiation information data 456 in data storage unit 45 (step K5). Simultaneously, specification matching processor 308 also stores the contents requested by a customer and the user name entered at step K1 as specification matching data 452 in data storage unit 45 (step K6). However, the data of the contents requested by a customer and the price requested by a seller are stored in a coordinated relationship in a table different from the data of the product specifications, negotiation information and so forth. This means that the data are coordinated in a 1:N corresponding relationship so that price matching can be performed plural times for one product specification. Simultaneously, specification matching processor 308 reads the e-mail address of the person who performs the specification matching registered in mail transmission destination storage unit 42 (step K7), and mail transmitter 303 transmits to the person who performs the specification matching via e-mail a notification that a specification matching request has been received (step K8).

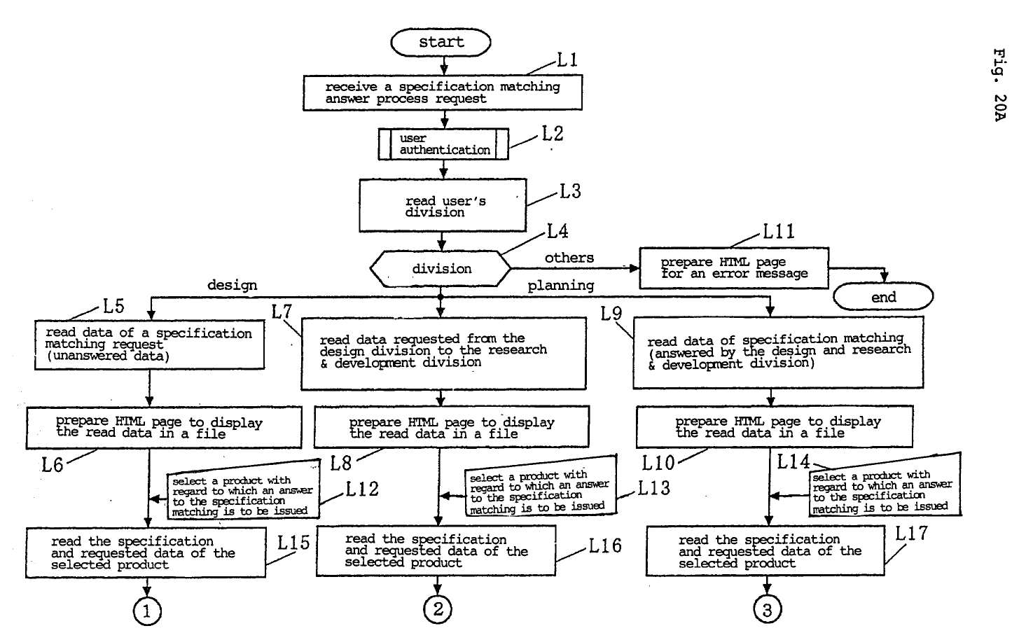

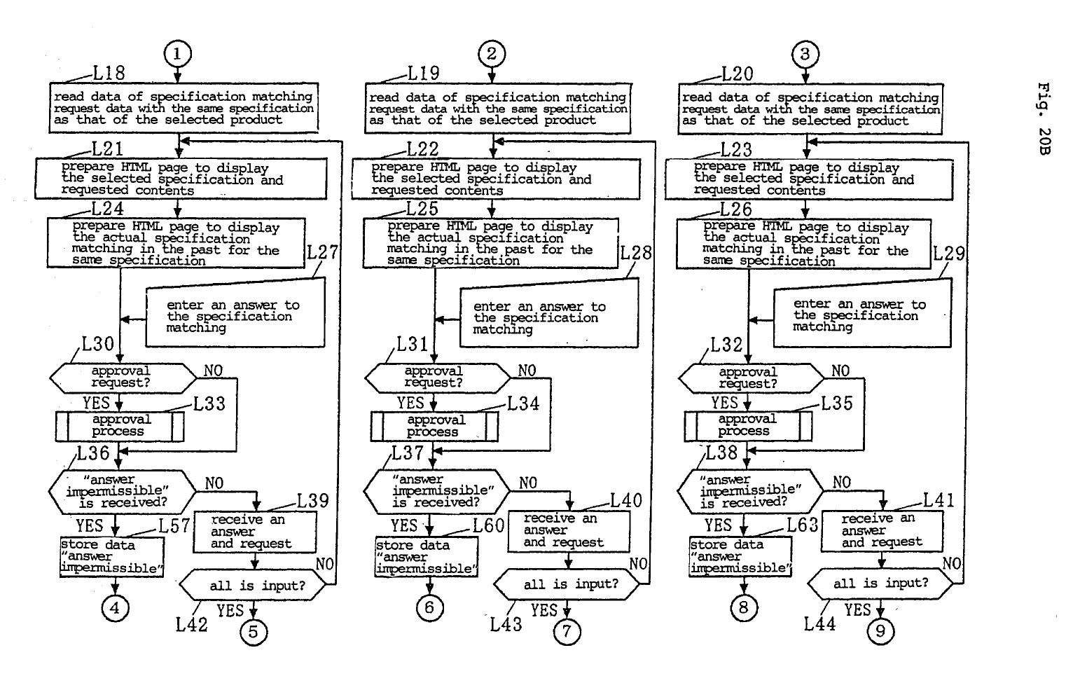

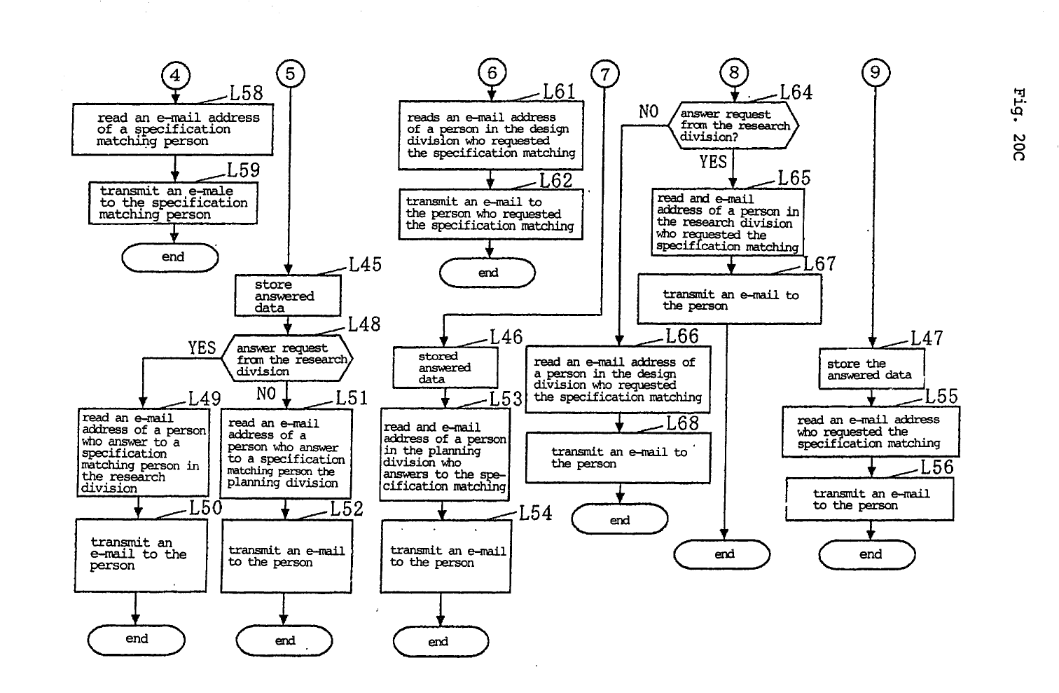

6.2 Specification Matching Answer (FIGS. 20A to 20C)

When a person answers the result of the specification matching, he may issue a request for a specification matching answer process from user terminal 1 to center server 5. When WWW server 2 matching answer process receives the request from the user (step L1), user authentication unit 302 performs user authentication (step L2), reads the division of the user stored in user information storage unit 41 (step L3), and determines the division of the user (step L4). The design engineering division, research & development division and planning division are in charge of the specification matching.

When the division of the user is the design engineering division, specification matching processor 308 reads non-answered data for the specification matching request from data storage unit 45 (step L5), and HTML page preparation unit 301 prepares HTML page data to display an answer list of the design engineering for the specification matching request (step L6). When the division of the user is the research & development division, specification matching processor 308 reads specification matching request data with regard to which a request for answer has been issued from the design engineering division to the research & development division, from data storage unit 45 (step L7), and HTML page preparation unit 301 prepares HTML page data to display an answer of the research & development division for the specification matching request (step L8). When the division of the user is the planning division, specification matching processor 308 reads the specification matching request data with regard to which answers of the design engineering division and the research & development division are completed, from data storage unit 45 (step L9), and HTML page preparation unit 301 prepares HTML page data to display an answer list of the planning division for the specification matching request (step L10). When the division of the user is a division other than the design engineering division, research & development division and planning division, HTML page preparation unit 301 prepares HTML page data to display a message representing that the user does not have a connection right to center server 5 with regard to a specification matching answer (step L11) and does not prepare HTML page data to display a specification matching request list.

The user may select a product with regard to which an answer should be given from the specification matching request contents list on user terminal 1 and issue a request for displaying specifications of the product with regard to which a specification matching answer should be given, contents of the request and an answer entering screen (steps L12 to L14). When WWW server 2 receives the request, specification matching processor 308 reads the product specifications and the requested price stored in data storage unit 45 (steps L15 to L17). Simultaneously, specification matching processor 308 reads from data storage unit 45 contents of the request and contents of answer for product data having the same specifications as those of the entered data (steps L18 to L20). The data thus read are specification matching actual result data of the past and are used as a reference for the current specification matching.

HTML page preparation unit 301 prepares HTML page data to display product specifications and contents of request, perform entry of an answer price and display specification matching actual results of the past with regard to the same specifications (steps L21 to L23, L24 to L25).

The user will determine an answer based on the displayed contents, enter an answer from user terminal 1 (steps L27 to L29). At this time, the user may additionally enter a request for approval. When WWW server 2 receives the approval request from the user terminal (YES at steps L30 to L32), approval processor 304 performs an approval process (steps L33 to L35), and after the approval process, WWW server 2 guides the user to issue an answer end request from user terminal 1. Since it is not likely to occur at all that, when an approval request is issued, an answer cannot be given, the determination at next steps L36 to L38 is “NO” without fail. When WWW server 2 does not receive an approval request from the user terminal (NO at steps L30 to L32), WWW server 2 skips steps L33 to L35 and guides the user to a request for an answer end or answer impermissibility. “Answer end” means that matching specifications have successfully been answered, and “answer impermissibility” means that it is impermissible to answer of the specification matching for some reason.

When WWW server 2 receives the answer end request (steps L39 to L41), specification matching processor 308 confirms that an answer has been entered (steps L42 to L44) and registers the contents of the answer in data storage unit 45 (steps L45 to L47). When an answer has not been entered or there are some items whose data are not entered (NO at steps L42 to L44), HTML page preparation unit 301 prepares HTML page data to display that there are some items whose data are not entered and to enter an answer (steps L21 to L23).

When the user who has issued the answer end request belongs to the design engineering division, he may further issue a request of answer of the specification matching to the development division from user terminal 1. In this case (YES at step L48), when WWW server 2 receives the request, specification matching processor 308 reads an email address of a person in the research & development division who answers the specification matching from mail transmission destination storage unit 42 (step L49), and mail transmitter 303 transmits to the person in the research & development division who answers the specification matching via an e-mail a notification that a request for a specification matching answer has been received (step L50). When the user does not issue the request for a specification matching answer to the research & development division (NO at step S48), specification matching processor 308 reads an e-mail address of a person in the planning division who answers the specification matching from mail transmission destination storage unit 42 (step L51), and mail transmitter 303 transmits to the person who answers the specification matching via an e-mail a notification that a request for a specification matching answer has been received (step L52).

On the other hand, if the user who has issued the answer end request belongs to the research & development division, specification matching processor 308 reads an email address of the person in the planning division who answers the specification matching from mail transmission destination storage unit 42 (step L53), and mail transmitter 303 transmits to the person who answers the specification matching by an e-mail a notification that a request for a specification matching answer has been received (step L54). Further, if the user who has issued the answer end request belongs to the planning division, specification matching processor 308 reads the user name of a person (typically a salesperson) who requested the specification matching from data storage unit 45 and reads an e-mail address of the user from user storage unit 41 (step L55), and mail transmitter 303 transmits an e-mail to end answer to the sales person (step L56).

When WWW server 2 receives an answer impermissibility request from the user belonging to the design engineering division (YES at step L36), specification matching processor 308 registers “answer impermissibility” data into data storage unit 45 (step L57). Simultaneously, specification matching processor 308 reads the user name of the person who requested the specification matching (typically a salesperson) from data storage unit 45 and reads an e-mail address registered in user storage information unit 41 from the user name (step L58), and mail transmitter 303 transmits an e-mail of “answer impermissibility” data to the person who requested the specification matching (step L59).

When WWW server 2 receives an answer impermissibility request from the user belonging to the research & development division (YES at step L37), specification matching processor 308 stores “answer impermissibility” data in data storage unit 45 (step L60). Simultaneously, specification matching processor 308 reads the user name of a person in the design division who answers the specification matching (the person who requested the research & development division for the specification matching) from data storage unit 45 and reads an e-mail address registered in user storage unit 41 from the user name (step L61), and mail transmitter 303 transmits an email of “answer impermissibility” to a person of the design engineering division who answers the specification matching (step L62).

When WWW server 2 receives an answer impermissibility request from the user belonging to the planning division (YES at step L38), specification matching processor 308 stores “answer impermissibility” data in data storage unit 45 (step L63). Simultaneously, specification matching processor 308 reads the user name of the person in the research & development division who answers the specification matching (the person who requested the planning division to perform specification matching) when a specification matching answer from the development division has been received (YES at step L64). When a specification matching answer from the development division has not been received (NO at step L64), the person in the design engineering division who answers the specification matching from data storage unit 45 and reads an e-mail address registered in user information storage unit 41 from the user name (steps L65, L66), and mail transmitter 303 transmits an e-mail of “answer impermissibility” to a person in the research & development division who answers the specification matching and a person in the design engineering division who answers the specification matching (steps L67, L68).

As described above, the planning division possess the final determination right of an answer of the specification matching, and an answer of the specification matching issued by the design engineering division or the research & development division is transmitted to the planning division and the planning division issues the answer to the person who requested specification matching. There are three routes to obtain a specification matching answer: the planning division alone, a route from the design engineering division to the planning division and a route from the design engineering division through the research & development division to the planning division.

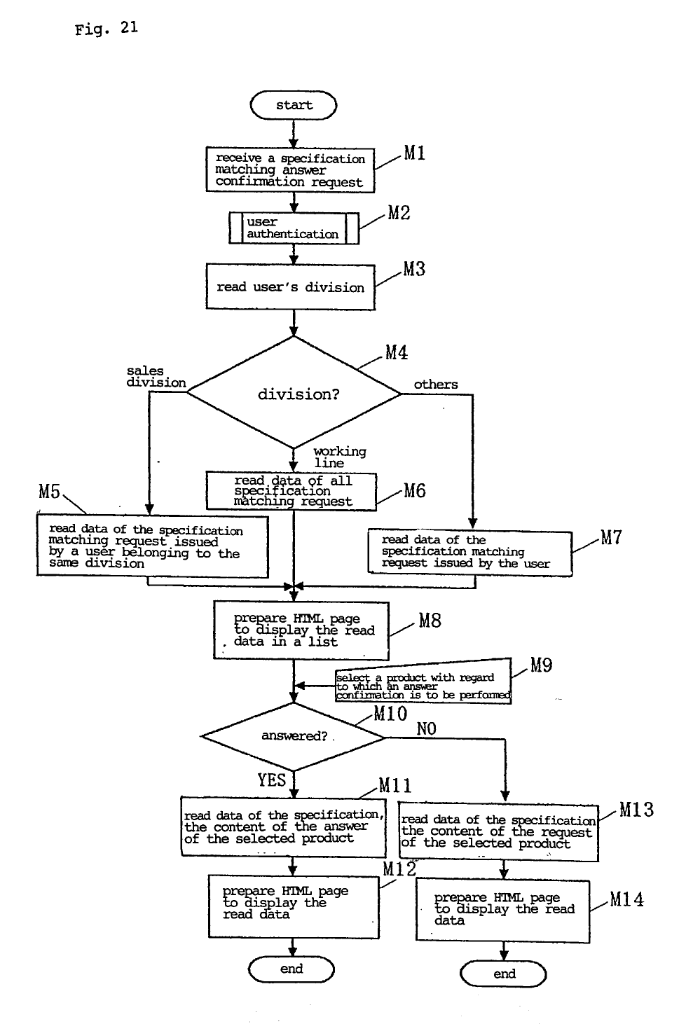

6.3 Specification Matching Answer Confirmation (FIG. 21)

A user in each division in the company may issue a request for the specification matching answer confirmation process from user terminal 1 to center server 5 in order to confirm an answer of the specification matching. When www server 2 receives a request for the specification matching answer confirmation (step M1), user authentication unit 302 performs user authentication (step M2) and reads the division of the user information stored in user information storage unit 41 (step M3). User authentication unit 302 then determines whether the division is the sales division, the business line (sales promotion division, design engineering division, research & development division, planning division, manufacturing division), or a division other than the sales division and the business line (step M4).

When the division of the user is the sales division, specification matching processor 308 reads data of specification matching requests issued by users of the same sales division from data storage unit 45 (step M5), and HTML page preparation unit 301 prepares HTML page data to display the read data in a list (step M8). When the division of the user is the business line, specification matching processor 308 reads data of all specification matching requests from data storage unit 45 (step M6), and HTML page preparation unit 301 prepares HTML page data to display the read data in a list (step M8). When the user belongs to a division other than the sales division and the business line, specification matching processor 308 reads data of specification matching requests by the user himself from data storage unit 45 (step M7), and HTML page preparation unit 301 prepares HTML page data to display the read data in a list (step M8).

The user may select a product with regard to which answer confirmation is desired to be performed from the specification matching request list on user terminal 1 to issue a request for displaying specifications, the contents of the request and the contents of the answer (step M9). When WWW server 2 receives the request, if it has issued an answer (YES at step M10), then specification matching processor 308 reads the content of the specifications, the contents of the request and an answer of the selected product from data storage unit 45 (step M11). HTML page preparation unit 301 prepares HTML page data to display the read data (step M12). On the other hand, if an answer has not been issued (NO at step M10), then specification matching processor 308 reads the product specifications and the contents of the request from data storage unit 45 (step M13), and HTML page preparation unit 301 prepares HTML page data to display the contents of the request, a processing state and contents of a next process (step M14).

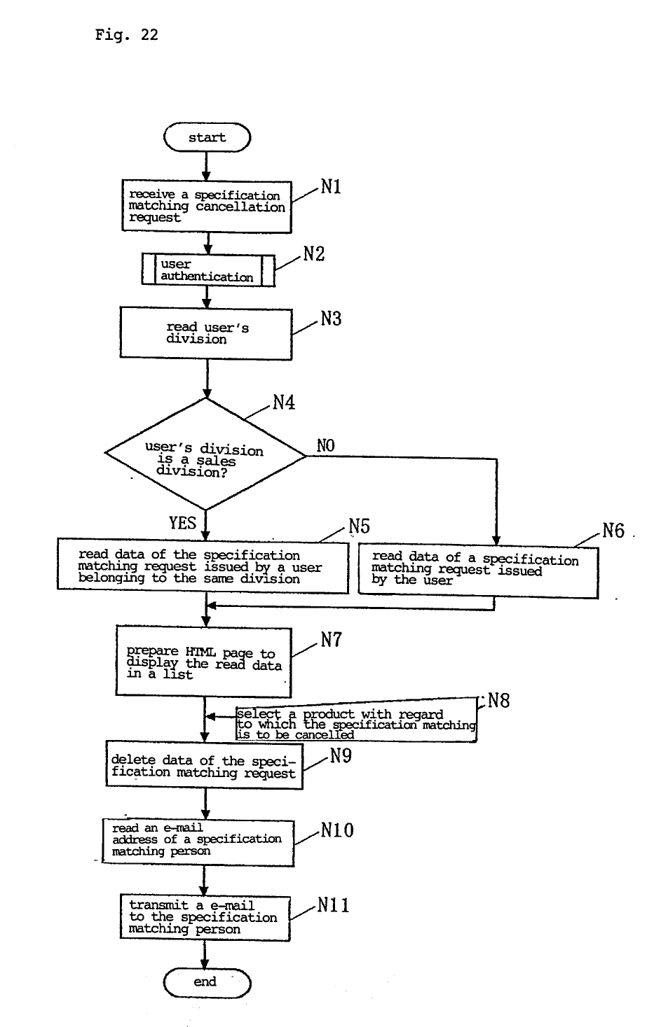

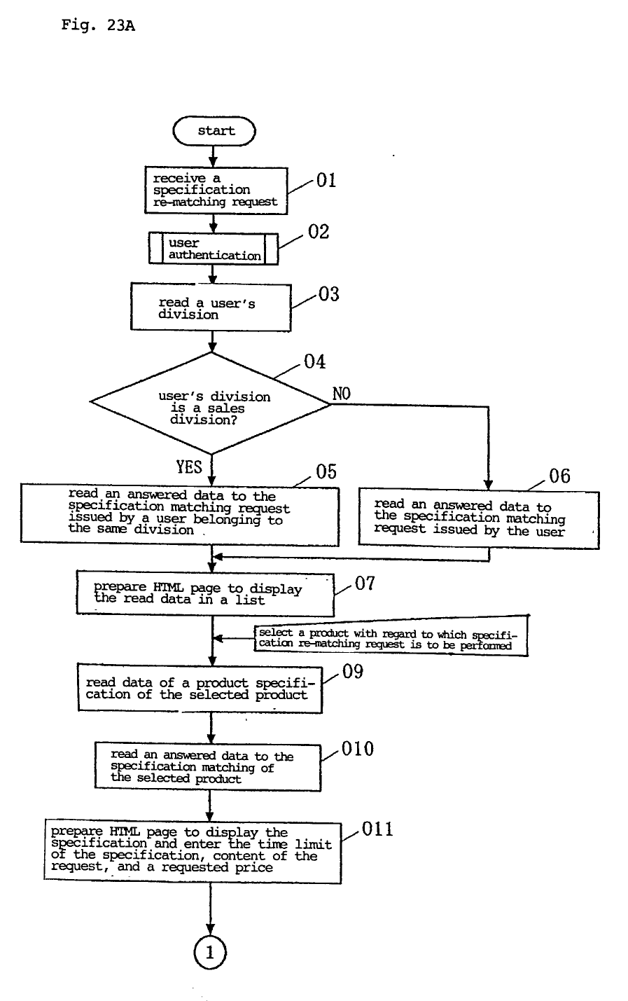

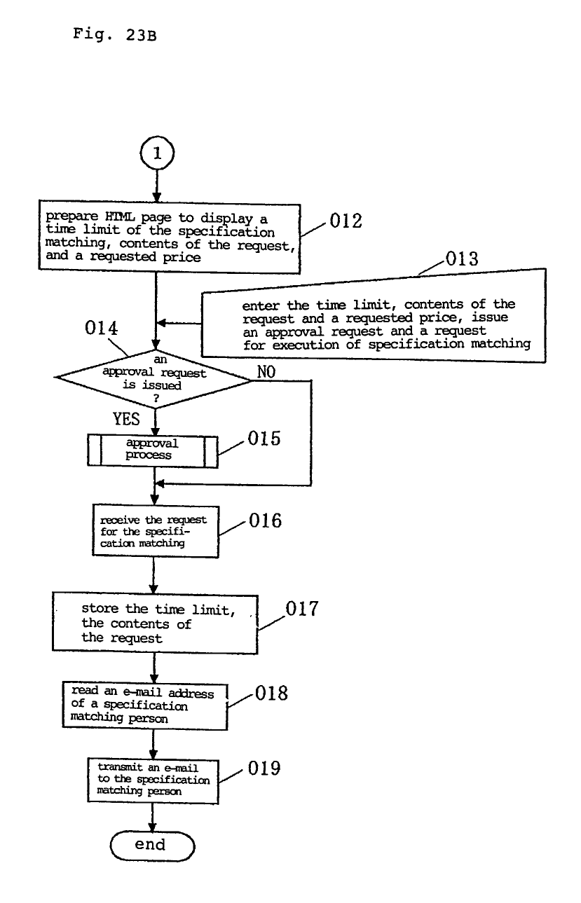

6.4 Specification Matching Cancellation (FIG. 22)

An answer to a submitted specification matching request may become unnecessary for some reason (e.g., change of the specifications for the convenience of the customer). In this case, the user may issue a request for specification matching cancellation from user terminal 1. When WWW server 2 receives the request for specification matching cancellation (step N1), user authentication unit 302 performs user authentication (step N2) and reads the division of the user stored in user information storage unit 41 (step N3).

When the division of the user is the sales division (YES at step N4), specification matching processor 308 reads data of specification matching requests issued by users of the sales division from data storage unit 45 (step N5), and HTML page preparation unit 301 prepares HTML page data to display the read data in a list (step N7). When the division of the user is a division other than the sales division (NO at step N4), specification matching processor 308 reads data of price matching requests issued by the user himself from data storage unit 45 (step N6), and HTML page preparation unit 301 prepares HTML page data to display the data in a list (step N7).

The user may select a product with regard to which the specification matching request is desired to be cancelled from the specification matching request list and issue a request for specification matching cancellation (step N8). When WWW server 2 receives the request, specification matching processor 308 deletes data of the contents of the request, user name and so forth registered in data storage unit 45 (step N9) and simultaneously reads the mail address of the person who performed the specification matching registered in mail transmission destination storage unit 42 (step N10), and mail transmitter 303 transmits to the person via an e-mail a notification that the specification matching request has been cancelled (step N11).

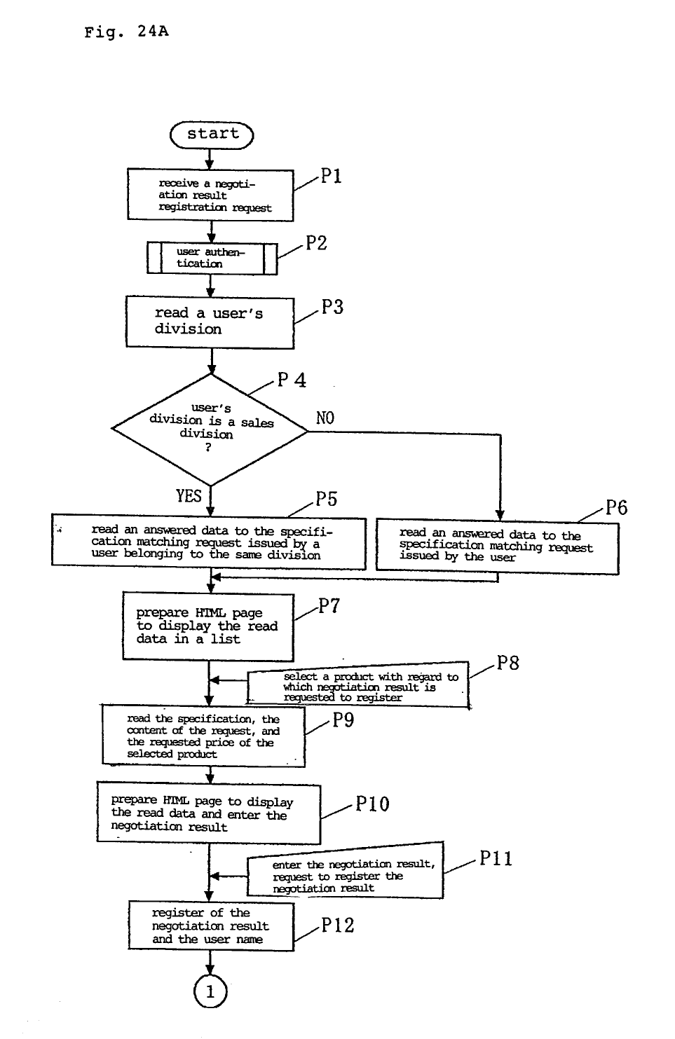

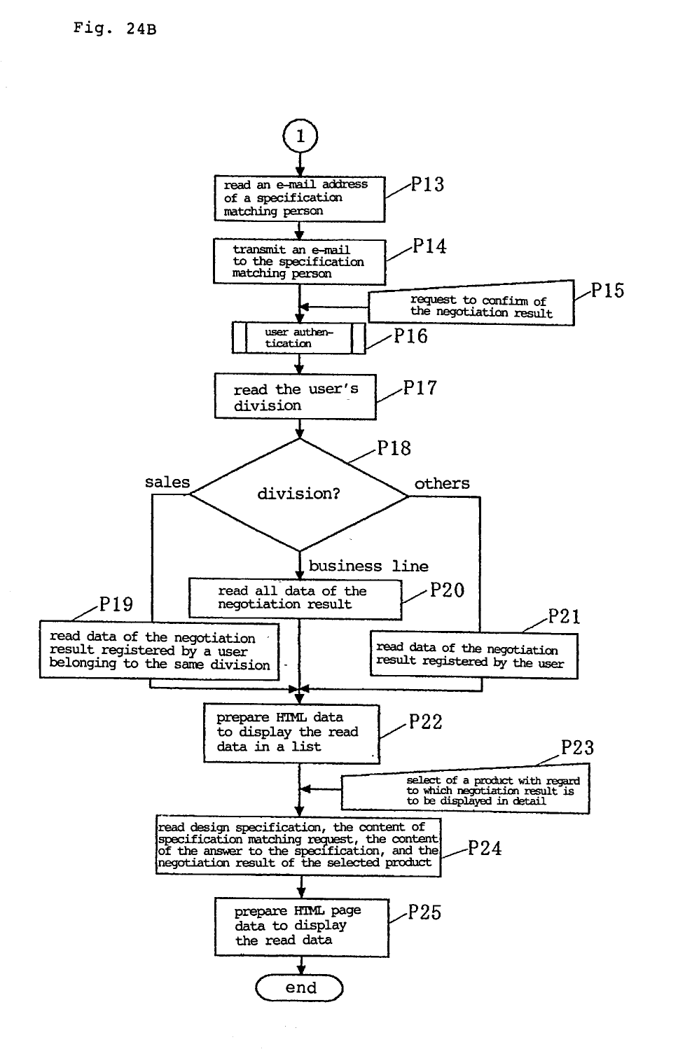

6.5 Specification Re-Matching Request (FIGS. 22, 23)

A user who has issued a request for a specification matching and confirmed an answer but is not satisfied with the answer may issue a request for a specification re-matching to center server 5 from user terminal 1. When WWW server 2 receives the request for specification re-matching (step O1), user authentication unit 302 performs user authentication (step O2) and reads the division of the user registered in user information storage unit 41 (step O3).

When the division of the user is the sales division (YES at step O4), specification matching processor 308 reads answered data to specification matching requested by users of the sales division from data storage unit 45 (step O5), and HTML page preparation unit 301 prepares HTML page data to display the read data in a list (step O7). When the division of the user is a division other than the sales division (NO at step O4), specification matching processor 308 reads answered data to the specification matching requested by the user himself from data storage unit 45 (step O6), and HTML page preparation unit 301 prepares HTML page data to display the read data in a list (step O7).

The user may select a product with regard to which a specification re-matching request is desired to be issued from a specification matching request answer list and issue a request for display of an entering screen for product specifications and contents of the request (step O8). When WWW server 2 receives the request, specification matching processor 308 reads the product specifications registered in data storage unit 45 (step O9), and HTML page preparation unit 301 prepares HTML page data to display the product specifications and to enter contents of the request (step O11). Further, specification matching processor 308 reads specification matching data 452 of the past from data storage unit 45 (step O12), and HTML page preparation unit 301 prepares HTML page data to display specification matching data 452 of the past thus read. In this case, since the product specifications were already registered in data storage unit 45, HTML page data to enter product specifications are not prepared.

The user may enter contents of the request from user terminal 1 and issue a request for approval of the contents of the request (step O13). When WWW server 2 receives the approval request from the user (YES at step O14), approval processor 304 performs an approval process (step O15), and after the approval process, WWW server 2 guides the user to issue a request for executing a specification matching (step O13). When WWW server 2 does not receive an approval request from the user (NO at step O14), WWW server 2 skips step O15 and guides the user to issue a request for executing specification matching.

When the WWW server 2 receives the request for executing specification matching (step O16), specification matching processor 308 registers the contents of the request and the user name in data storage unit 45 (step O17). The data are registered as data separate from the data of specification matching requests of the past. This is because it is intended to register the data in a 1:n coordinated relationship so that specification matching may be performed plural times for one product specification. Simultaneously, specification matching processor 308 reads the e-mail address of the person who performed the specification matching registered in mail transmission destination storage unit 42 (step O18), and mail transmitter 303 transmits to the person via an e-mail a notification that a specification matching request to the person who performs the specification matching has been received (step O19).

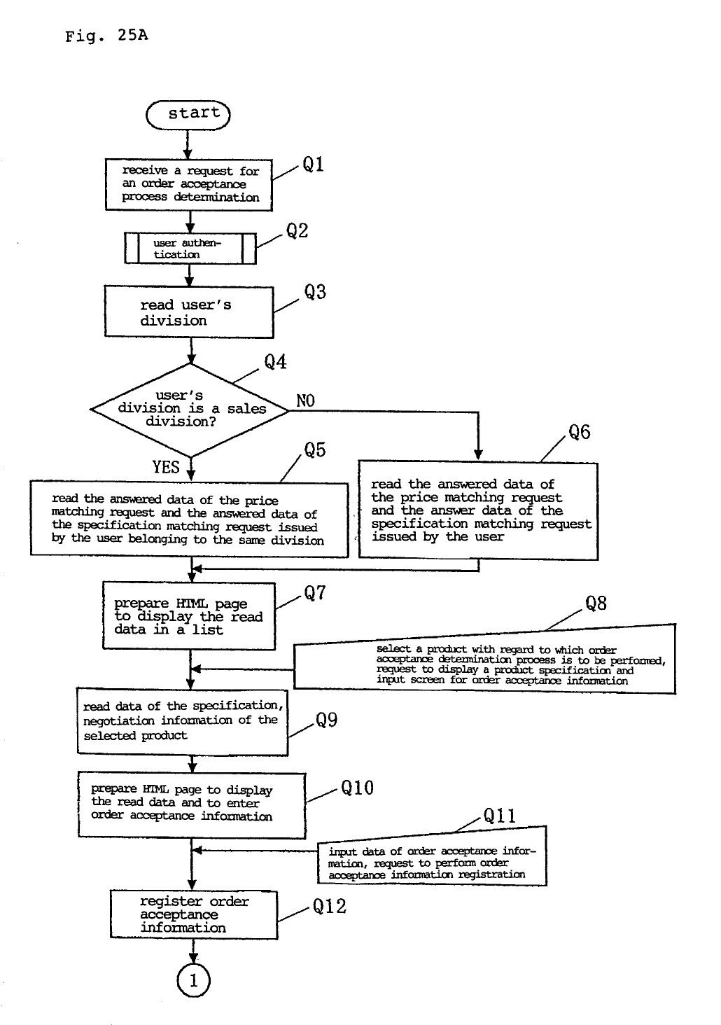

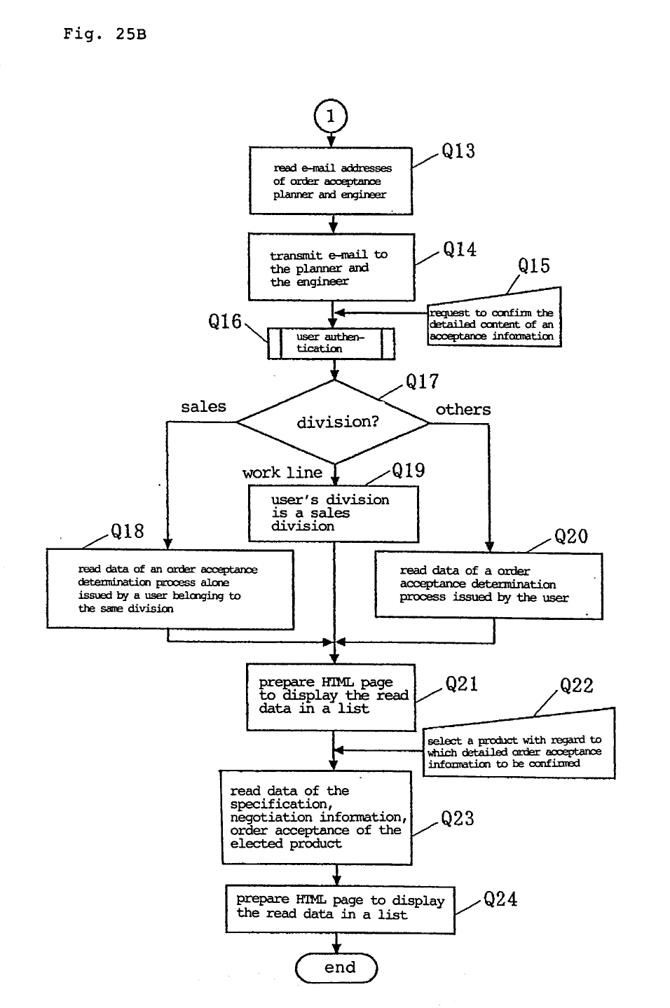

6.6 Negotiation Result Registration (FIGS. 24A, 24B)

The user will present the price matching result as an estimated price to the customer and proceeds with the negotiation. When the negotiation results in success or failure, the result must be transmitted to the business line. When the negotiation results in failure, the user may issue a request for registering the negotiation result to center server 5 from user terminal 1. When WWW server 2 receives the request for registering the negotiation result (step P1), user authentication unit 302 performs user authentication (step P2) and reads the division of the user registered in user storage unit 41 (step P3).

When the division of the user is the sales division (YES at step P4), specification matching processor 308 reads answered data to the price matching requested by users of the sales division from data storage unit 45 (step P5), and HTML page preparation unit 301 prepares HTML page data to display the read data in a list (step P7). When the division of the user is a division other than the sales division (NO at step P4), specification matching processor 308 reads answered data to the price matching requested by the user himself from data storage unit 45 (step P6), and HTML page preparation unit 301 prepares HTML page data to display the read data in a list (step P7).

The user may select a product with regard to which the negotiation result registration is desired to be performed from the price matching request answer list on user terminal 1 and issue a request for display of a negotiation result entering screen (step P8). When WWW server 2 receives the request, specification matching processor 308 reads the product specifications of the selected product, the content of the request and the content of the answer from data storage unit 45 (step P9), and HTML page preparation unit 301 prepares HTML page data to display the product specifications, contents of the request and contents of the answer and to enter a negotiation result (step P10).

The user may enter the negotiation result from user terminal 1 to issue a request for execution of a negotiation result registration (step P11). When WWW server 2 receives the request for execution of the negotiation result registration, specification matching processor 308 registers the negotiation result and the user name in data storage unit 45 (step P12). Simultaneously, specification matching processor 308 reads an e-mail address of the person who performs the specification matching stored in mail transmission destination storage unit 42 (step P13), and mail transmitter 303 transmits to the person via an e-mail a notification that negotiation result registration has been performed (step P14).

Further, the user may issue a request for confirmation of the negotiation result from user terminal 1 (step P15). When WWW server 2 receives the request for confirmation of the negotiation result, user authentication unit 302 performs user authentication (step P16) and reads the division of the user registered in user information storage unit 41 (step P17), and then determines the division (step P18).

When the division of the user is the sales division, specification matching processor 308 reads negotiation result of users in the same sales division from data storage unit 45 (step P19), and HTML page preparation unit 301 prepares HTML page data to display the read data in a list (step P22). When the division of the user is the business line, specification matching processor 308 reads all negotiation result from data storage unit 45 (step P20), and HTML page preparation unit 301 prepares HTML page data to display the read data in a list (step P22). When the division of the user is a division other than the sales division and the business line, specification matching processor 308 reads the negotiation result of the user himself from data storage unit 45 (step P21), and HTML page preparation unit 301 prepares HTML page data to display the read data in a list (step P22).

The user may also select a product with regard to which particulars of the negotiation result is desired to be displayed from the negotiation result list on user terminal 1 and issue a request for display of the particulars to center server 5 (step P23). When WWW server 2 receives the request for display of particulars of the negotiation result, specification matching processor 308 reads design specifications of the selected product, contents of matching request, contents of matching answer, the negotiation result and so forth from data storage unit 45 (step P24), and HTML page preparation unit 301 prepares HTML page data to display the read data (step P25).

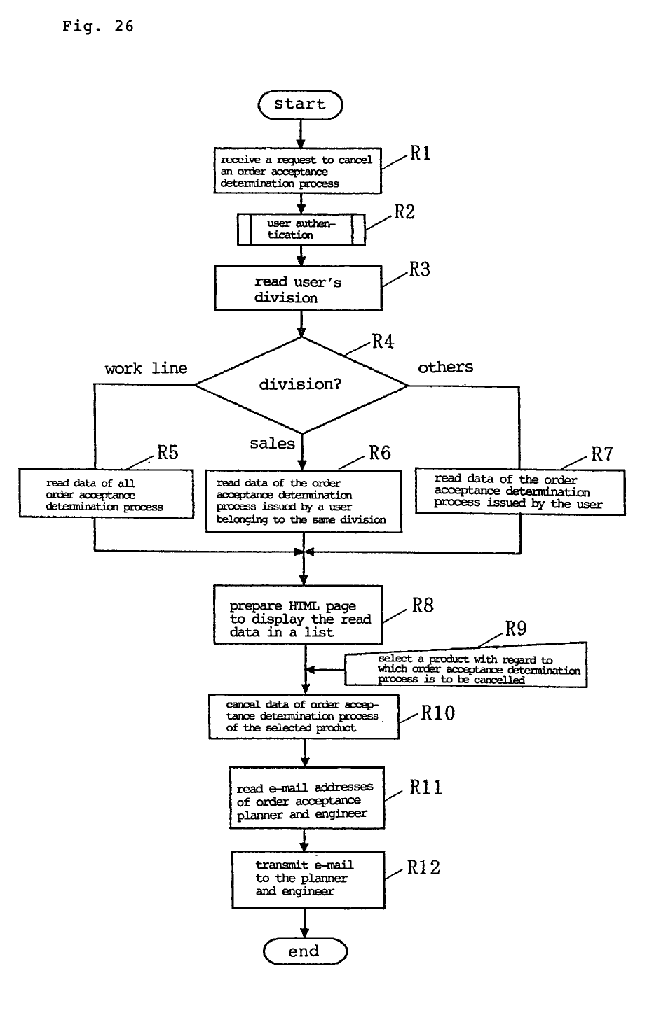

7. Order Acceptance Determination Process 107 (FIGS. 25A to 27)

WWW server 2 provides a user, typically a salesperson with the price matching result or the specification result in a manner described above. The salesperson will present them as a price estimate or a specification estimate to the customer to proceed with the negotiation. Thereafter, the salesperson may issue a request for an order acceptance determination process to center server 5 from user terminal 1.

7.1 Order Acceptance Determination Process (FIGS. 25A, 25B)

When WWW server 2 receives a request for an order acceptance determination process (step Q1), user authentication unit 302 performs user authentication (step Q2) and reads the division registered in user information storage unit 41 (step Q3), and then determines the division of the user (step Q4). When the division of the user is the sales division (YES at step Q4), order acceptance processor 309 reads price matching data 451 and specification matching answered data 452 to the requests issued by users of the sales division from data storage unit 45 (step Q5), and HTML page preparation unit 301 prepares HTML page data to display a list of answers to the price matching and specification matching (step Q7). When the division of the user is a division other than the sales division (NO at step Q4), order acceptance processor 309 reads price matching answered data 451 and specification matching data 452 to the requests issued by the user himself from data storage unit 45 (step Q6), and HTML page preparation unit 301 prepares HTML page data to display a list of answers of the price matching and specification matching (step Q7).

The salesperson may select a product with regard to which an order acceptance determination is desired to be performed from the list of answers of the price matching and specification matching on user terminal 1 and issue a request for display of a product specification and order acceptance information entering screen (step Q8). When WWW server 2 receives the request, order acceptance processor 309 reads the product specification data 457 and the negotiation information data 456 registered through the price matching and specification matching from data storage unit 45 (step Q9), and HTML page preparation unit 301 prepares HTML page data to display the design specification and the negotiation information and enter order acceptance information data (step Q10).

The salesperson may enter the order acceptance data (order number, a time limit for delivery, quantity and so forth) as order acceptance information from user terminal 1 to issue a request for execution of order acceptance information registration (step Q11). At this time, the design specification and the negotiation information are not entered since they have been already registered as data. When WWW server 2 receives the request for execution of order acceptance information registration, order acceptance processor 309 registers the order acceptance data and the user name as the order acceptance information in data storage unit 45 (step Q12). Simultaneously, order acceptance processor 309 reads an e-mail addresses of a person who is in charge of the order acceptance plan and a person who is in charge of engineering registered in mail transmission destination storage unit 42 (step Q13), and mail transmitter 303 transmits to the person who is in charge of the order acceptance plan and the person who is in charge of engineering via an e-mail a notification that order acceptance information registration has been performed and a URL (Uniform Resource Locator) to display order acceptance data 453 as a reference (step Q14).

The person who is in charge of the order acceptance plan and the person who is in charge of engineering may issue a request for confirmation of particular contents of the order acceptance information from user terminal 1 (step Q15). When WWW server 2 receives the request for confirmation of particular contents of the order acceptance data information, user authentication unit 302 performs user authentication (step Q16) and reads the division of the user registered in user information storage unit 41 (step Q17).

If the division of the user is the sales division, order acceptance processor 309 reads order acceptance data 453 with regard to which an order acceptance determination process has been performed by users of the sales division from data storage unit 45 (step Q18). When the division of the user is the business line, order acceptance processor 309 reads all order acceptance data 453 with regard to which an order acceptance determination process has been performed from data storage unit 45 (step Q19). When the division of the user is a division other than the sales division and the business line, order acceptance processor 309 reads order acceptance data 453 requested by the user himself from data storage unit 45 (step Q20). HTML page preparation unit 301 prepares HTML page data to display the data thus read in a list (step Q21). WWW server 2 transmits the prepared HTML page data to user terminal 1.

The user may select a product with regard to which particulars of contents of the order acceptance determination process is de-sired to be confirmed from the order acceptance determination process list on user terminal 1 and issue a request for confirmation of particulars of contents of the order acceptance determination to center server 5 (step Q22). When WWW server 2 receives the request, order acceptance processor 309 reads product specification data 457, negotiation information data 456, order acceptance data 453 of the pertinent product from data storage unit 45 (step Q23), and HTML page preparation unit 301 prepares HTML page data to display particulars of contents of the order acceptance information (step Q24).

7.2 Order Acceptance Determination Process Cancellation (FIG. 26)

After an acceptance determination process has been performed, the acceptance determination process thus performed may become unnecessary for some reason (e.g.; the order acceptance has been canceled for the convenience of the customer). In this case, a user may issue a request for cancellation of the order acceptance determination process from user terminal 1. When WWW server 2 receives the request for cancellation of the order acceptance determination process (step R1), user authentication unit 302 performs user authentication (step R2) and reads the division of the user stored in user information storage unit 41 (step R3). User authentication unit 302 determines the division of the user (step R4).

When the division of the user is the sales division, order acceptance processor 309 reads data of order acceptance determination processes requested by users of the same sales division; when the division is the business line, order acceptance processor 309 reads all order acceptance data 453; and when the user belongs to a division other than the sales division and the business line, order acceptance processor 309 reads order acceptance data 453 requested by the user himself, from data storage unit 45 (steps R5, R6, R7). HTML page preparation unit 301 prepares HTML page data to display the read data in a list (step R8). WWW server 2 transmits the prepared HTML page data to user terminal 1.

The user may select a product with regard to which the order acceptance determination process is desired to be canceled from the order acceptance determination process list on user terminal 1 to issue a request for cancellation of the order acceptance determination process (step R9). When WWW server 2 receives the request, order acceptance processor 309 cancels data of the contents of the request, user name and so forth registered in data storage unit 45 (step R10). Simultaneously, order acceptance processor 309 reads an e-mail addresses of the person who is in charge of the order acceptance plan and the person who is in charge of engineering registered in the mail transmission destination storage unit 42 (step R11), and mail transmitter 303 transmits to the person who is in charge of the order acceptance plan and the person who is in charge of engineering via an e-mail a notification that the order acceptance determination process has been canceled (step S12).

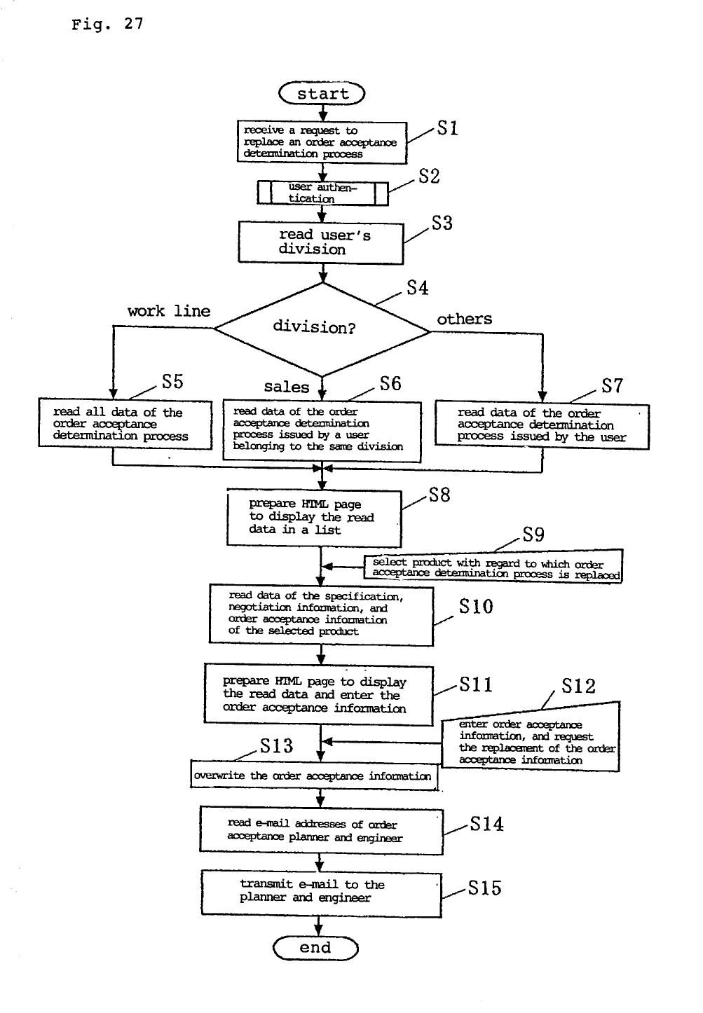

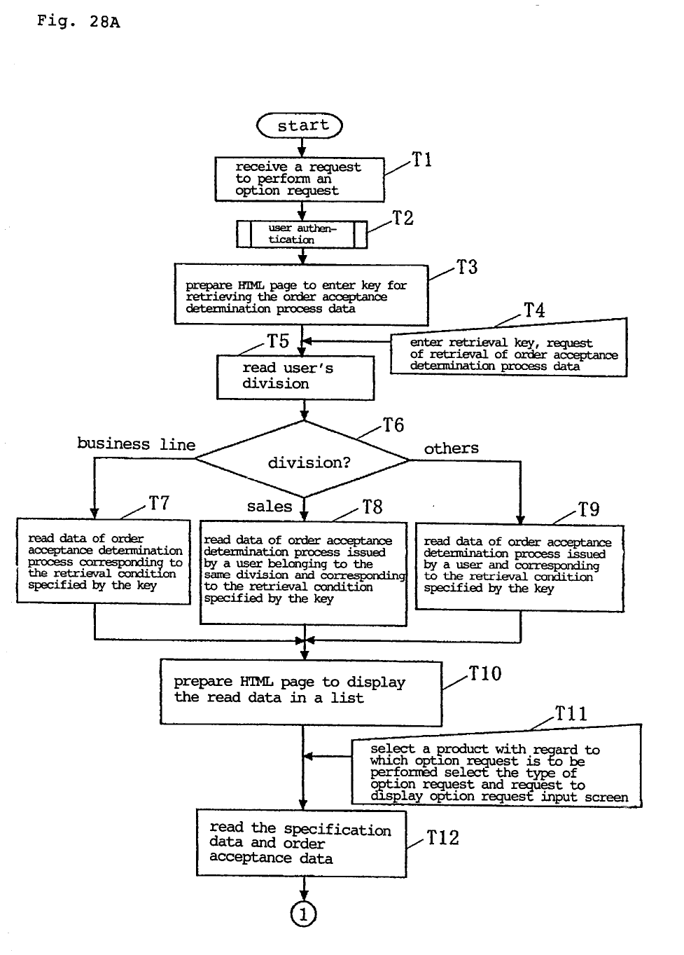

7.3 Order Acceptance Determination Process Replacement (FIG. 27)

After an acceptance determination process has been performed, it is sometimes desirable to change the contents of the acceptance determination process thus performed for some reason (e.g.; the time limit for delivery has been changed for the convenience of the customer). At this time, the user may issue a request for replacement of the order acceptance determination process from user terminal 1. When WWW server 2 receives the request for replacement of the order acceptance determination process (step S1), user authentication unit 302 performs user authentication (step S2) and reads the division of the user stored in user information storage unit 41 (step S3). User authentication unit 302 determines the division of the user (step S4).

When the division of the user is the sales division, order acceptance processor 309 reads order acceptance data 453 requested by users of the sales division; when the division of the user is the business line, order acceptance processor 309 reads all order acceptance data 453; and when the user belongs to a division other than the sales division and the business line, order acceptance processor 309 reads order acceptance data 453 requested by the user himself, from data storage unit 45 (steps S5, S6, S7). HTML page preparation unit 301 prepares HTML page data to display the read data in a list (step S8). WWW server 2 transmits the prepared HTML page data to user terminal 1.

The user may select a product with regard to which the order acceptance determination process is desired to be replaced from the order acceptance determination process list on user terminal 1 (step S9). When WWW server 2 receives contents of the selection, order acceptance processor 309 reads order acceptance data 453 of the selected product from data storage unit 45 (step S10). HTML page preparation unit 301 prepares HTML page data to display the design specifications and negotiation information and enter order acceptance data 453 (step S11), and WWW server 2 transmits the prepared HTML page data to user terminal 1.

The user may enter order acceptance information to be changed on user terminal 1 to issue a request for replacement of order acceptance data 453 (step S12). When WWW server 2 receives the request, order acceptance processor 309 registers order acceptance data 453 and the user name by overwriting in data storage unit 45 (step S13). Simultaneously, order acceptance processor 309 reads an e-mail addresses of the person who is in charge of the order acceptance plan and the person who is in charge of engineering registered in mail transmission destination storage unit 42 (step S14), and mail transmitter 303 transmits to the person who is in charge of the order acceptance plan and the person who is in charge of engineering via e-mail a notification that the order acceptance information replacement registration has been performed and a URL of WWW server 2 which displays order acceptance data 453 (step S15).

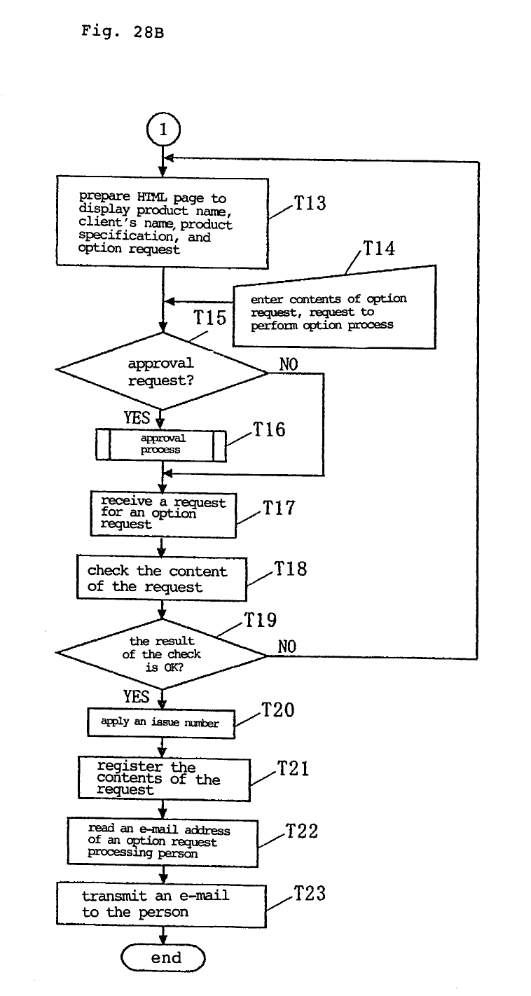

8. Option Request Process 108 (FIGS. 28A to 30)

After an order of a custom product is accepted, a customer sometimes requests an option article relating to the custom product, for example, metal mask data or a film in the example of a printed circuit board. When such a request is received from a customer, the present system performs the following processes.

8.1 Option Request Execution (FIGS. 28A, 28B)

A user, typically a salesperson, may issue a request for execution of the option request to center server 5 from user terminal 1. When WWW server 2 receives the request for execution of the option request (step T1), user authentication unit 302 performs user authentication (step T2) and HTML page preparation unit 301 prepares HTML page data to enter a retrieval key (article name, customer name, date of order acceptance determination processing or the like) for retrieving order acceptance data 453 with regard to which an order acceptance determination process has been performed (step T3).

The user may enter a retrieval key from user terminal 1 to issue a request for retrieval of order acceptance data 453 to WWW server 2 (step T4). When WWW server 2 receives the request for retrieval of the order acceptance data 453, option processor 310 reads from data storage unit 45 order acceptance data 453 that satisfies the retrieval conditions (step T5). Further, option processor 310 reads the division of a user who requested the retrieval registered in user information storage unit 41 in accordance with conditions included in the retrieval conditions and then determines the division of the user (step T6).

When the division of the user is the sales division, option processor 310 reads order acceptance data 453 alone registered by users of the sales division; when the division of the user is the business line, option processor 310 reads all order acceptance data 453; and when the user belongs to a division other than the sales division and the business line, option processor 310 reads order acceptance data 453 registered by the user himself, from data storage unit 45 (steps T7, T8, T9). HTML page preparation unit 301 prepares HTML page data to display a retrieval result list from order acceptance data 453 thus read (step T10).

The salesperson may select a product with regard to which an option request is desired to be issued and a kind of option request from the retrieval result list from user terminal 1 to issue a request for display of an option request entering screen (step T11). When WWW server 2 receives the request for display of the option request entering screen, option processor 310 reads data of the pertinent product registered in data storage unit 45 (step T12). HTML page preparation unit 301 prepares HTML page data to display product specification such as an article name and a customer name together with an option request entering screen (step T13).

If WWW server 2 receives an approval request from the user, which request is issued when the content of the option request is entered (step T11), approval processor 304 performs an approval process (step T16). After the approval process, WWW server 2 guides the user to issue a request for execution of the option request. When WWW server 2 does not receive the approval request from the WWW server 2 (NO at step T15), WWW server 2 skips step T16 and guides the user to issue the request for execution of the option request.

When WWW server 2 receives the request for execution of the option request (step T17), option processor 310 checks the contents of the request (step T18). The check of the contents may differ depending on articles of the option request. In the case of a printed circuit board, it is determined whether or not the required number of films and so on are entered. If no data is entered (NO at step T19), HTML page preparation unit 301 prepares HTML page data to display the option request entering screen again (step T13), and WWW server 2 transmits the prepared HTML page data to user terminal 1. If data is entered (YES at step T19), option processor 310 takes an issue number (step T20) and registers the issue number, user name, processing date, contents of the option request and so forth as option request data 454 in data storage unit 45 (step T21). Simultaneously, option processor 310 reads an e-mail address of a person who requested the option request processing registered in mail transmission destination storage unit 42 (step T22), and mail transmitter 303 transmits to the person via an e-mail a notification that an option request has been issued (step T23).

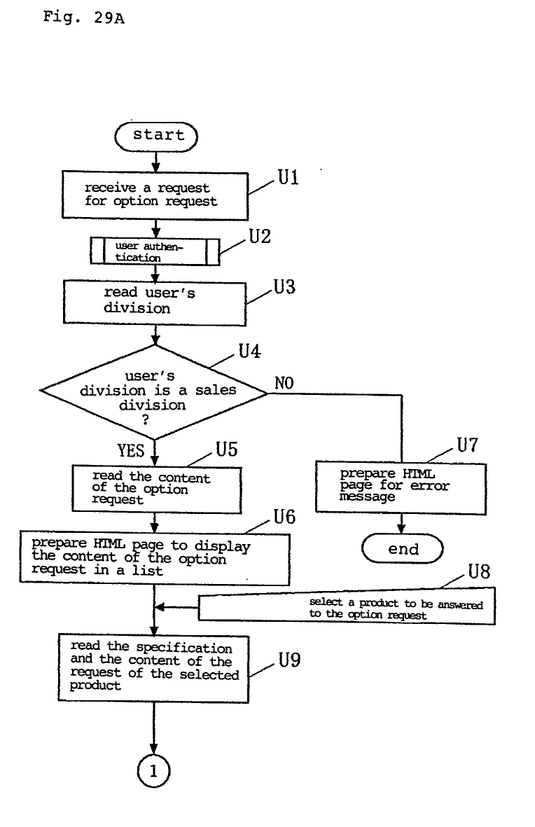

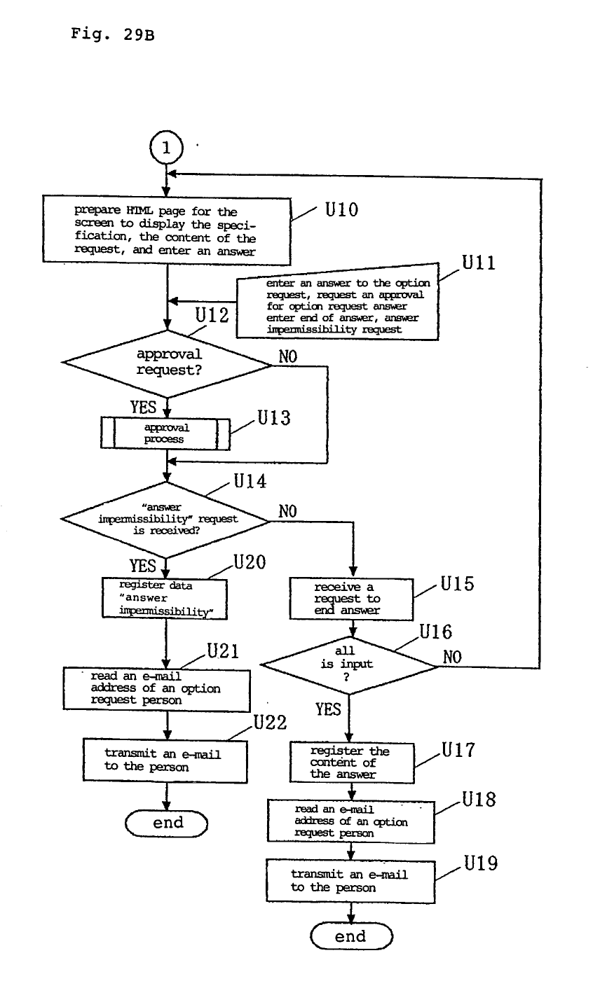

8.2 Option Request Answer (FIGS. 29A, 29B)

The user may issue a request for an option request answer process from user terminal 1. When WWW server 2 receives the request for option request answer process from the user terminal (step U1), user authentication unit 302 performs user authentication (step U2) and reads the division of the user registered in user information storage unit 41 (step U3).

When the division of the user is an option request processing division (for example, the manufacturing division in the case of the manufacture of a film for a printed circuit board) (YES at step U4), option processor 310 reads option request data 454 from data storage unit 45 (step U5), and HTML page preparation unit 301 prepares HTML page data to display an option request list (step U6). When the division of the user is a division other than the option request processing division (NO at step U4), HTML page preparation unit 301 prepares HTML page data to notify the user of an error message that the user does not have a connection right to center server 5 (step U7) and does not produce HTML page data for an option request list.

The user may select a product with regard to which an answer is desired to be given from the option request list from user terminal 1 and issue a request for display of specification of a product with regard to which an option answer is desired to be given, display of the contents of the request and an answer entering screen to center server 5 (step U8). When WWW server 2 receives the request, option processor 310 reads product specification and contents of the request registered in data storage unit 45 (step U9), and HTML page preparation unit 301 prepares HTML page data to display the product specification and the contents of the request and to enter an answer (step U10)

When WWW server 2 receives an approval request from the user (YES at step U12), which is issued when issuing the option answer request (step U11), approval processor 304 performs an approval process (step U13). When WWW server 2 does not receive an approval request from the WWW server 2 (NO at step U12), WWW server 2 guides the user to issue an answer end request or an answer impermissibility request.

When WWW server 2 receives the answer end request (YES at step U14), and an answer is entered (YES at step U16), option processor 310 registers the answer in data storage unit 45 (step U17). Simultaneously, option processor 310 reads from data storage unit 45 the user name of the salesperson who has registered the option request and reads an e-mail address of the user name registered in user information storage unit 41 (step U18), and mail transmitter 303 transmits an e-mail to notify the completion of answer to the salesperson (step U19). When an answer is not entered or there are some items whose data are not entered (NO at step U16), HTML page preparation unit 301 prepares HTML data to notify that there are some items whose data are not entered and to enter an answer (step U10).

On the other hand, when WWW server 2 receives an answer impermissibility request (YES at step U14), option processor 310 registers “answer impermissibility” in data storage unit 45 (step U20). Simultaneously, option processor 310 reads the user name of the user from data storage unit 45 and reads an e-mail address of the user name registered in user information storage unit 41 (step U21), and mail transmitter 303 transmits an e-mail to notify of the impermissibility of an answer to the user (step U22).

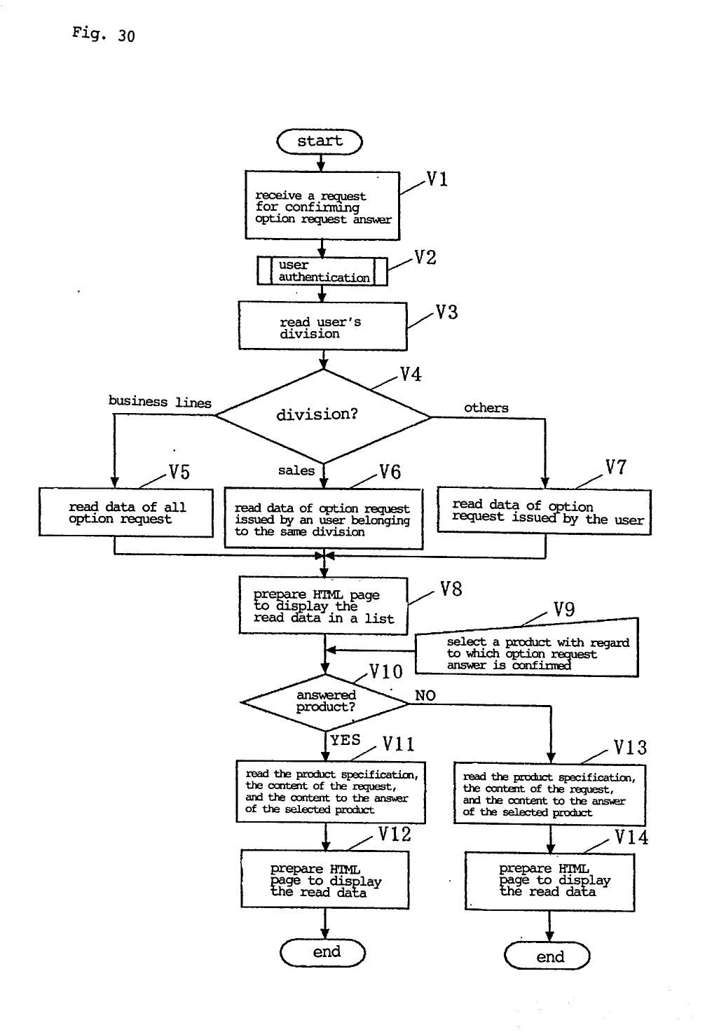

8.3 Option Request Answer Confirmation (FIG. 30)

A user may issue a request for an option matching answer confirmation process from user terminal 1. When WWW server 2 receives the request for an option matching answer confirmation process (step V1), user authentication unit 302 performs user authentication (step V2), reads the division of the user registered in user information storage unit 41 (step V3), and determines the division of the user (step V4).

When the division of the user is the same sales division, option processor 310 reads data of the option matching requested by users of the sales division; when the division of the user is the business line, option processor 310 reads data of all option matching; and when the user belongs to a division other than the sales division and the business line, option processor 310 reads data of the option matching requested by the user himself, from data storage unit 45 (steps V5, V6, V7). HTML page preparation unit 301 prepares HTML page data to display the read data in a list (step V8).

The user may select a product with regard to which answer confirmation is desired to be performed from the option matching request list from user terminal 1 to issue a request for display of the specifications, contents of the request and contents of the answer (step V9). When WWW server 2 receives the request and an answer of the option request with regard to the selected product has been already issued (YES at step V10), option processor 310 reads the product specification, contents of the request and contents of the answer from data storage unit 45 (step V11). HTML page preparation unit 301 prepares HTML page data to display the read data (step V12).

When there is no answer (NO at step V10), option processor 310 reads the product specification and contents of the request from data storage unit 45 (step V13), and HTML page preparation unit 301 prepares HTML page data to display contents of the request, a processing state and contents of a next process (step V14).

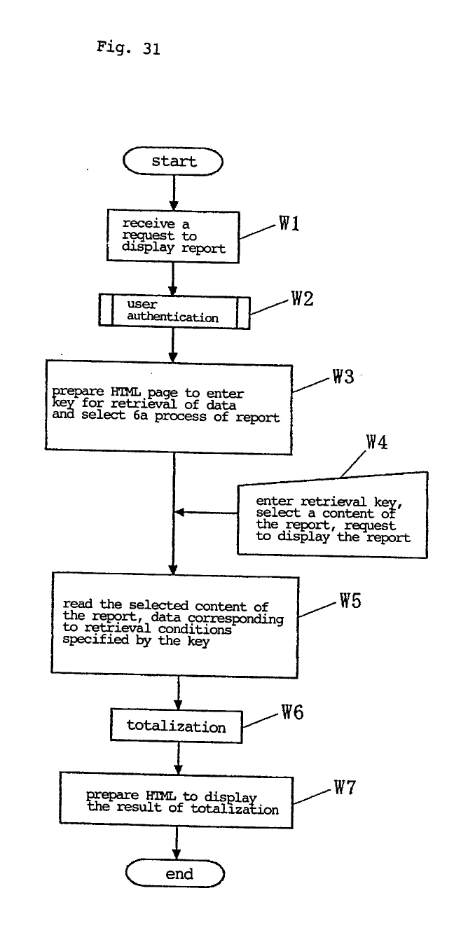

9. Report Outputting Process (FIG. 31)

A user may issue a request for display of a report of order acceptance activities to center server 5 from user terminal 1. When WWW server 2 receives the request (step W1), user authentication unit 302 performs user authentication (step W2), and HTML page preparation unit 301 prepares HTML page data to enter retrieval conditions and to select contents to be reported (step W3).

The user may enter retrieval conditions (a month, an item of the axis of abscissa of a graph and so forth) and select contents of the report (order acceptance determination data for each lodgment) to issue a request for display of the report to center server 5 (step W4). When WWW server 2 receives the request, report preparation unit 311 reads the data registered in data storage unit 45 in accordance with the retrieval conditions and the contents of the report (step W5) and counts the number of data for each month and each lodgment (step W6), and HTML page preparation unit 301 prepares HTML page data of the counted result in the form of a graph and a table (step W7).

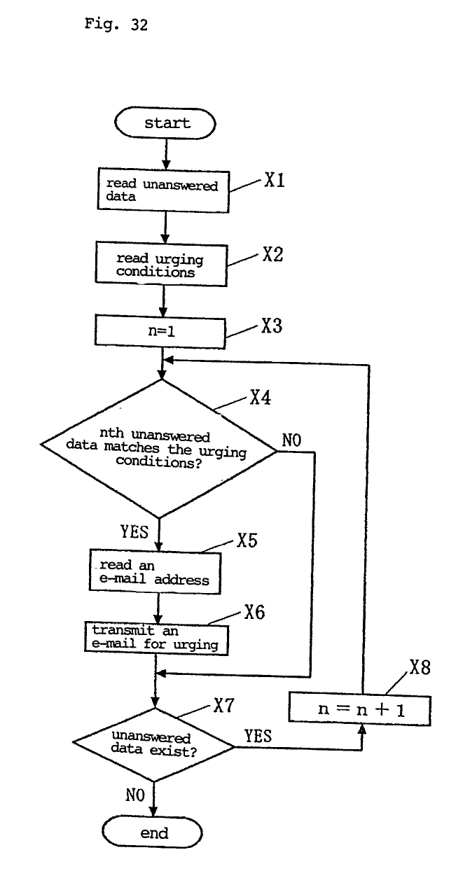

10. Urging Process 110 (FIG. 32)

Since the order acceptance activities proceed under the cooperation of several divisions as described above, any tie-up of the processing by a particular division must be prevented. WWW server 2 scans data storage unit 45 every day, and if it finds that an answer of the request is not registered and an urging condition set for-contents of each request in advance is satisfied, it transmits an answer-urging mail to a person who issues an answer. The urging condition set for contents of each request includes every N days or every day elapsed after the time limit for delivery of an answer, for example.

Urging processor 312 checks at a fixed time every day whether or not a request whose answer is not registered in data storage unit 45, a specification matching request, for example, is registered (step X1). If such a request is registered, then urging processor 312 reads the urging condition registered in data storage unit 45 (step X2) and checks whether or not the requested specification matching matches the urging condition (step X4). If the requested specification matching matches the urging condition (YES at step S4), urging processor 312 reads an e-mail address of the person who performs the specification matching registered in mail transmission destination storage unit 42 (step X5), and mail transmitter 303 transmits an e-mail to urge the person who performs specification matching for an answer (step X6).

Such a sequence of processes is repeated for all unanswered data (steps X3, X7, X8). Such urging is performed with regard to a price matching request, input of a negotiation result, answer of an option request and so forth in addition to the specification matching request.

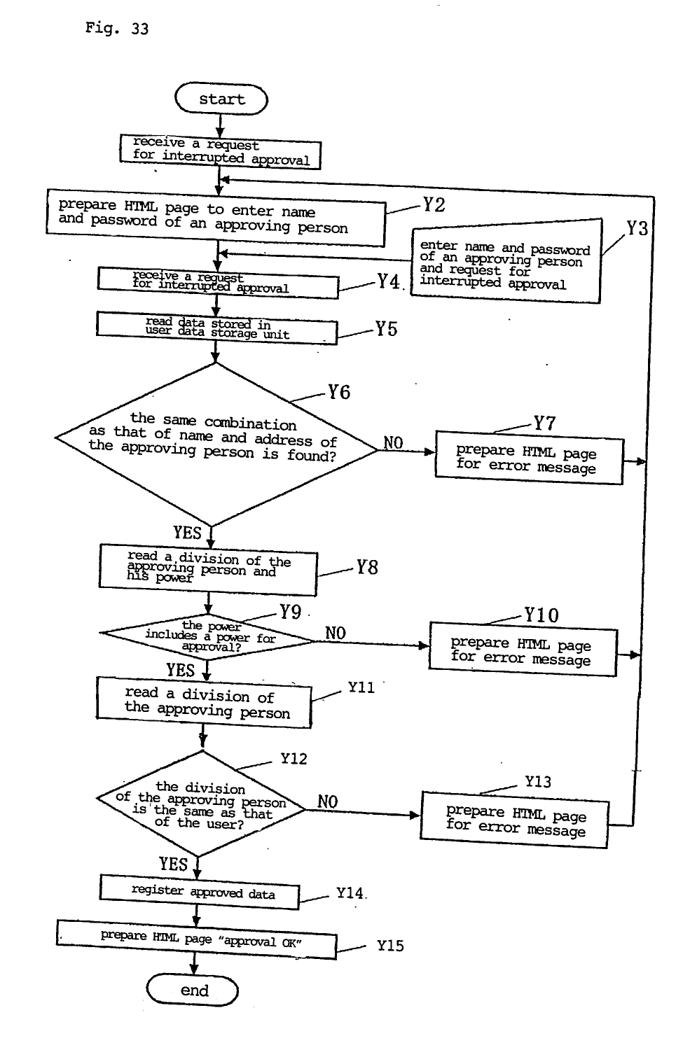

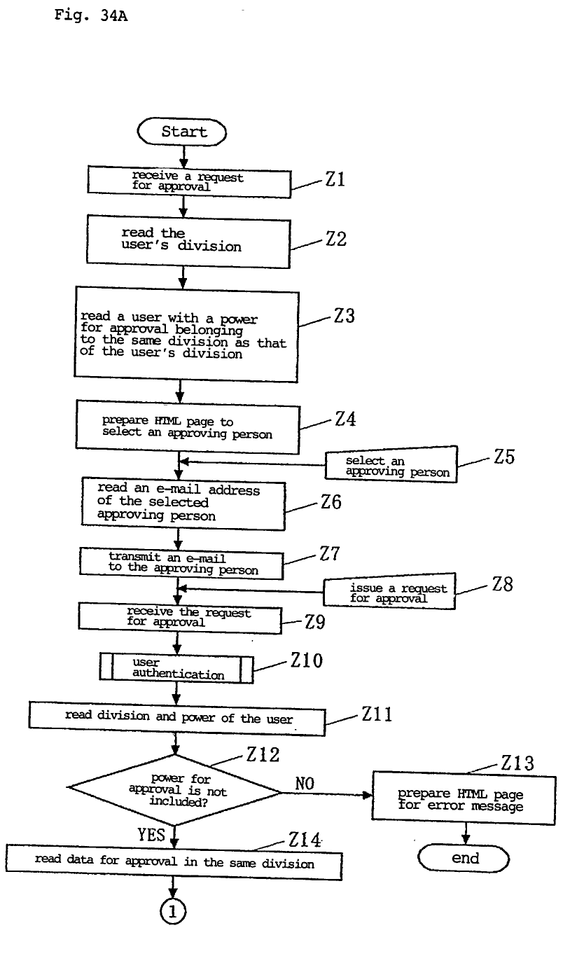

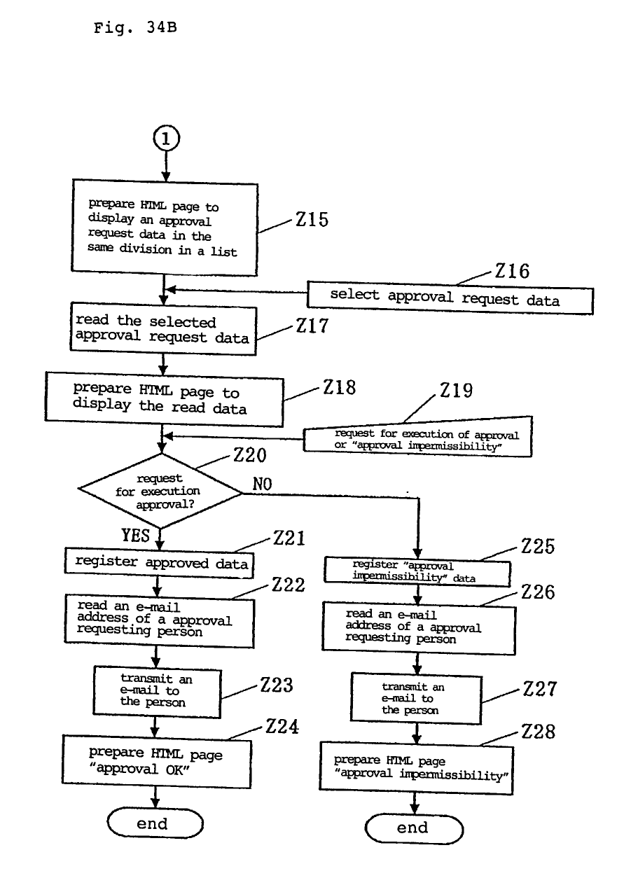

11. Approval Process 111 (FIGS. 33 to 34B)

Of the processes described above, the price matching request, price matching answer, price re-matching request, specification matching request, specification matching answer, specification re-matching request, option request execution and option request answer may additionally include an approval process. Step D3 of FIG. 12 showing a flow chart of the price matching request, for example, includes such an approval process. The approval includes an interrupted approval requested by a person who performs approving and an approval request requested by a person who requests an approval. In either case, a user may issue a request for execution of an approval to center server 5 from user terminal 1. This request is also performed on a menu screen (step B7 of FIG. 10) delivered from WWW server 2 upon user authentication.

11.1 Interrupt Approval (FIG. 33)

When WWW server 2 receives a request for interrupted approval (step Y1), HTML page preparation unit 301 prepares HTML page data to enter a user name and a password of a person who performs approving (step Y2).

The user (a person who performs approving) may enter the user name and the password of the person from user terminal 1 to issue a request for execution of an interrupted approval to center server 5 (step Y3). When WWW server 2 receives the user name and the password of the person who performs approving (step Y4), approval processor 304 reads data from user information storage unit 41 (step Y5) and checks whether or not the same combination as that of the user name and the password of the person who performs approving is stored in user information storage unit 41 (step Y6). If the same combination is not found (NO at step Y6), HTML page preparation unit 301 prepares HTML page data to display that the user name and the password of the person who performs approving are wrong (step Y7). If the same combination is found (YES at step Y6), approval processor 304 reads a power and a division of the person who performs approving from user information storage unit 41 (step Y8) and checks whether or not the person has the power for approval (step Y9). When the power does not include the power for approval (NO at step Y9), HTML page preparation unit 301 prepares HTML page data to display that the person who performs approving does not have the power for approval (step Y10). When the power includes the power for approval (YES at step Y9), approval processor 304 reads the division of the user (a person who requested approval) from user information storage unit 41 (step Y11). This is possible because the approval process is performed during the execution of the price matching or the like, and the user who has issued the request for the price matching or the like is recognized by approval processor 304. Approval processor 304 determines whether or not the division of the user is the same as the division of a person who performed approving (step Y12). When the divisions are not the same (NO at step Y12), HTML page preparation unit 301 prepares HTML page data to display that both divisions are different from each other (step Y13).

When the both divisions are the same (YES at step Y12), approval processor 304 stores the approved data in user information storage unit 41 (step Y14), and HTML page preparation unit 301 prepares HTML page data to display “approved” (step Y15).

11.2 Approval Request (FIGS. 34A, 34B)

When WWW server 2 receives a request for approval (step Z1), approval processor 304 reads the division of the user from user information storage unit 41 (step Z3) and reads the name of a user who belongs to the same division as that of the user and have the approval power from user information storage unit 41 (step Z3). HTML page preparation unit 301 prepares HTML page data to select a person who performs the approval process (step Z4).

The user (a person who requested an approval) may select a person who performs an approval process from user terminal 1 (step Z5). When WWW server 2 receives the result of the selection from the user terminal, approval processor 304 reads an e-mail address of the selected person from user information storage unit 41 (step Z6), and mail transmitter 303 transmits an e-mail for requesting an approval (step Z7).

The user (a person who performs the approval process) who received the e-mail may issue a request for an approval process from user terminal 1 (step Z8). When WWW server 2 receives the request from the user terminal (step Z9), user authentication unit 302 performs authentication process (step Z10), and approval processor 4 reads the power and the division of the user registered in user information storage unit 41 (step Z11). When the power does not include the approval power (NO at step Z12), HTML page preparation unit 301 prepares HTML page data to display that the user (a person who performed an approval process) does not have the power (step Z13).

When the power of the user includes the approval power (YES at step Z12), approval processor 304 reads data of the approval request issued by users of the same division (step Z14), and HTML page preparation unit 301 prepares HTML page data to display a list of the data (step Z15).

The user may select an approval request with regard to which an approval process is desired to be performed from user terminal 1 (step Z16). When WWW server 2 receives the selected result from the user terminal, approval processor 304 reads contents of the selected approval request from data storage unit 45 (step Z17), and HTML page preparation unit 301 prepares HTML page data to display the data (step Z18).

The user may issue a request for approval execution or approval impermissibility (step Z19). When WWW server 2 receives the approval execution request from the user (YES at step Z20), approval processor 304 registers the approved data in data storage unit 45 (step Z21). Further, approval processor 304 reads an e-mail address of a person who requested the approval from mail transmission destination storage unit 42 (step Z22), and mail transmitter 303 transmits an e-mail to the person (step Z23). HTML page preparation unit 301 prepares HTML page data to display that an approval has been performed (step Z24).

On the other hand, when WWW server 2 receives an approval impermissibility request from the user (NO at step Z20), approval processor 304 registers “approval impermissibility” data in data storage unit 45 (step Z25). Further, approval processor 304 reads an e-mail address of a person who requested the approval from mail transmission destination storage unit 42 (step Z26), and mail transmitter 303 transmits an e-mail to the person (step Z27). HTML page preparation unit 301 prepares HTML page data to display that an approval is impermissible (step Z28).

An application server and a customer terminal may be used in place of WWW server 2 and the browser in the embodiment described above. Further, a server and a client computer may be constructed on a machine such that a network is not used for communication of data.

While the embodiment of the present invention has been described above, the present invention allows the following modifications.

Each of the price estimation process and the specification analysis process may be constructed separately as an application program from the center server.

Further, in the embodiment, the price matching process is described on the assumption of communication between a salesperson and the sales promotion division as an example. However, communication among three or more division is also possible. Communications between the specification matching process and a salesperson, the design engineering division and the planning division is assumed in the embodiment. However, communication among four or more divisions is also possible.

Further, the HTML page preparation unit 301 prepares HTML page data. However, it may prepare a page of text data or XML (Extensible Markup Language) data instead of HTML page data.

Furthermore, in the embodiment, it is assumed that the custom product is a printed circuit board. However, the present invention is not limited to this but can also be applied to order acceptance support of general custom products.

While preferred embodiments of the present invention have been described using specific terms, such description is for illustrative purposes only, and it is to be understood that changes and variations may be made without departing from the spirit or scope of the following claims.

What is claimed is:

1. A custom product order acceptance supporting method, wherein, when a request from a user terminal is received, data are prepared to display on said user terminal a menu of functions which can be utilized depending on a division of the user and which includes price estimation and price matching of a custom product.

2. A custom product order acceptance supporting method, wherein, when a request from a user terminal is received, data are prepared to display on said user terminal a menu of functions which can be utilized depending on a division of the user and which includes specification analysis and specification matching of a custom product.

3. A method of supporting, when an order of a custom product unique to a customer is accepted, a division which contacts the customer directly and a division which supports the former division, the method comprising the steps of:
preparing data to display on a terminal of the user a menu of functions which can be utilized depending on a division of the user;
calculating an estimated price when a request for a price estimation for the custom product including product specifications and negotiation information is received from the terminal of the user;
urging, when a request for a price matching is received, a terminal of a person who performs the price matching to issue an answer of the price matching; and
transmitting, when the answer is received from said terminal of the person who performs the price matching, the answer of the price matching to the terminal of a person who requested the price matching.

4. A custom of supporting, when an order of a custom product unique to a customer is accepted, a division which contacts the customer directly and a division which supports the former division, the method comprising the steps of:
preparing data to display on a terminal of the user a menu of functions which can be utilized depending on a division of the user;
analyzing manufacturing conditions and recommended conditions when a request for a specification analysis for the custom product including product specifications and negotiation information is received from the terminal of the user;
urging a terminal of a person who performs a specification matching to issue an answer of the specification matching when a request for the specification matching is received; and
transmitting, when the answer is received from the terminal of the person who performs the specification matching, the answer to the specification matching to the terminal of a person who requested the specification matching.

5. A custom product order acceptance supporting apparatus connected to user terminals in a company through an Intranet, the apparatus comprising:
price estimation means for calculating an estimated price when a request for a price estimation for a custom product including product specifications and negotiation information is received from said user terminal;
price matching means for transmitting, when a request for a price matching is received from said price estimation means, an e-mail to a terminal of a person who performs the price matching to urge the person to issue an answer of the price matching and for transmitting, when the answer is received from the terminal of the person who performs the price matching, the answer via e-mail to the user terminal of the person who requested the price matching;
storage means for storing therein data necessitated by said price estimation means and said price matching means and including price matching data of the past; and
transmission/reception means for receiving a request or data from said user terminal to activate a corresponding means of said price estimation means and said price matching means and transmitting the result of the process performed by said price estimation means and said price matching means to said user terminal.

6. The apparatus according to claim 5, wherein said price matching means further includes means for registering a plurality of data regarding a price requested by a customer and a price requested by a seller for each product uses item of negotiation information in a table different from that for data of the product specifications and negotiation information in said storage means.

7. The apparatus according to claim 5, wherein said price matching means includes means for preparing data to confirm an answer of the price matching within a range determined for each division of the user on said user terminal.

8. The apparatus according to claim 5, wherein said price matching means includes means for preparing data to cancel the request for the price matching on said user terminal.

9. The apparatus according to claim 5, wherein said price matching means includes means for preparing data to re-request the price matching on said user terminal.

10. The apparatus according to claim 5, wherein said price matching means includes means for preparing data to register the result of the negotiation in said apparatus on said user terminal.

11. The customer apparatus according to claim 5, further comprising order acceptance processing means for preparing data to enter and confirm order acceptance information or cancel or replace the order acceptance information on said user terminal.

12. The apparatus according to claim 5, further comprising option processing means for preparing data to request an option article associated with the custom product on said user terminal after the acceptance of the order of the custom product is determined.

13. The apparatus according to claim 5, further comprising report output processing means for preparing data to display the result of the order acceptance activities on said user terminal.

14. The apparatus according to claim 5, further comprising urging processing means for transmitting an email to urge a pertinent division to issue an answer when absence of an answer in the order acceptance activities satisfies conditions for urging.

15. A custom product order acceptance supporting apparatus connected to a user terminal in a company through an Intranet, the apparatus comprising:
specification analysis means for analyzing manufacturing conditions and recommended conditions when a request for a specification analysis for a custom product including product specifications and negotiation information is received from said user terminal;
specification matching means for transmitting, when a request for a specification matching is received from said specification analysis means, an e-mail to a terminal of a person who performs the specification matching to urge the person to issue an answer of the specification matching and for transmitting, when the answer is received from the terminal of the person who performs the specification matching, an e-mail to a user terminal of a person who requested the specification matching;
storage means for storing therein data necessitated by said specification analysis means and said specification matching means and including price matching data of the past; and
transmission/reception means for receiving a request or an input from said user terminal to activate a corresponding means said specification analysis means and said specification matching means and for transmitting the result of the process performed by said specification analysis means and said specification matching means to said user terminal.

16. The apparatus according to claim 15, wherein said specification matching means includes means for registering a plurality of data regarding a price requested by a customer and contents request by the customer for each one of the product specifications in a table different from data of the product specifications and the negotiation information in said storage means.

17. The apparatus according to claim 15, wherein said specification matching means includes means for preparing data to confirm an answer of the specification matching within a range determined for each division of the user on said user terminal.

18. The apparatus according to claim 15, wherein said specification matching means includes means for preparing data to cancel a request for the specification matching on said user terminal.

19. The apparatus according to claim 15, wherein said specification matching means includes means for preparing data to re-request the specification matching on said user terminal.

20. The apparatus according to claim 15, wherein said specification matching means includes means for preparing data to register a result of the negotiation in said apparatus on said user terminal.

21. The apparatus according to claim 15, further comprising order acceptance processing means for preparing data to enter and confirm order acceptance information or to cancel or replace the order acceptance information on said user terminal.

22. A customer product order acceptance supporting apparatus according to claim 15, further comprising option processing means for preparing data to request an option article associated with the custom product on said user terminal after the acceptance of the order of the custom product is determined.

23. An apparatus according to claim 15, further comprising report output processing means for preparing data to display a result of the order acceptance activities on said user terminal.

24. An apparatus according to claim 15, further comprising urging processing means for transmitting an email to urge a pertinent division to issue an answer when absence of an answer in the order acceptance activities satisfies conditions for urging.

25. A computer program for causing a computer to support, when an order of a custom product unique to a customer is accepted, a division which contacts the customer directly and a division which supports the former division, comprising:
a first instruction set for preparing data to display on a terminal of the user a menu of functions which can be utilized depending on a division of the user;
a second instruction set for calculating an estimated price when a price estimation request for the custom product including product specifications and negotiation information is received from the terminal of the user;
a third instruction set for transmitting, when a price matching request is received from the second instruction set, an e-mail to a terminal of a person who performs the price matching to urge the person to issue an answer of the price matching; and
a fourth instruction set for transmitting, when an answer to the price matching is received from the terminal of the person who performs the price matching, the answer via e-mail to the terminal of a person who required the price matching.

26. A computer program for causing a computer to support, when an order of a custom product unique to a customer is accepted, a division which contacts the customer directly and a division which supports the former division, comprising:
a first instruction set for preparing data to display on said user terminal a menu of functions which can be utilized depending on a division of the user;
a second instruction set for analyzing manufacturing conditions and recommended conditions when a specification analysis request for the custom product including product specifications and negotiation information is received from the terminal of the user;
a third instruction set for transmitting, when a specification matching request is received from the second instruction set, an e-mail to a terminal of a person who performs the specification matching to urge the person to issue an answer of the specification matching; and
a fourth instruction set of transmitting, when an answer to the specification matching is received from the terminal of the person who performs the specification matching, the answer to the terminal of a person who requested the specification matching.
